(19) United States
(12) Patent Application Publication
(10) Pub. No.: US 2023/0368295 A1
(43) Pub. Date: Nov. 16, 2023

(54) EQUIPMENT MANAGEMENT SERVER, TERMINAL DEVICE, INFORMATION PROCESSING SYSTEM, INFORMATION PROCESSING METHOD, STORAGE MEDIUM STORING INFORMATION PROCESSING PROGRAM, IMAGE DISPLAY METHOD, STORAGE MEDIUM STORING IMAGE DISPLAY PROGRAM, AND PRODUCT MANAGEMENT SERVER

(71) Applicant: Mitsubishi Electric Corporation, Tokyo (JP)

(72) Inventors: Daisuke NAKAMURA, Tokyo (JP); Mayu KAMAMOTO, Tokyo (JP); Sara ITO, Tokyo (JP); Kensho MOTOE, Tokyo (JP)

(73) Assignee: Mitsubishi Electric Corporation, Tokyo (JP)

(21) Appl. No.: 18/226,260

(22) Filed: Jul. 26, 2023

Related U.S. Application Data
(63) Continuation of application No. PCT/JP2021/004484, filed on Feb. 8, 2021.

(51) Int. Cl. G06Q 40/04

(52) U.S. Cl. CPC G06Q 40/04

(57) ABSTRACT

An equipment management server includes: an equipment information acquiring unit that acquires, from a first terminal device that registers equipment owned by a user, equipment information indicating the equipment; a demand determination unit that acquires the transaction result of the equipment indicated by the equipment information acquired by the equipment information acquiring unit in a secondhand products trading market, and determines whether or not there is a demand for the equipment in the secondhand products trading market on the basis of the transaction result; and a solicitation notice transmitting unit that transmits, to the first terminal device, a listing solicitation notice prompting listing of the equipment on the secondhand products trading market when the demand determination unit determines that there is a demand.

### CROSS-REFERENCE TO RELATED APPLICATION

The present application is a bypass-continuation of International Patent Application No. PCT/JP2021/004484, filed Feb. 8, 2021, the entire contents of which are incorporated herein by reference.

### TECHNICAL FIELD

The present disclosure relates to an equipment management server, a terminal device, an information processing system, an information processing method, a storage medium storing an information processing program, an image display method, a storage medium storing an image display program, and a product management server.

### BACKGROUND ART

One or more equipment owned by a user may include equipment that is usable but is not currently used. The equipment is, for example, various kinds of home appliances.

There is an auction processing device that prompts a user who owns equipment to put the equipment up for auction (see, for example, Patent Literature 1).

In the auction processing device, a user can register his/her equipment on a list (hereinafter referred to as “purchases list”) by operating his/her user terminal (hereinafter referred to as a “first user terminal”). In addition, another user can register desired equipment on a list (hereinafter referred to as “favorites list”) by operating his/her user terminal (hereinafter referred to as a “second user terminal”).

In the auction processing device, when the equipment registered on the “favorites list” matches the equipment registered on the “purchases list”, an auction server transmits, to the first user terminal, a notice prompting listing of the matching equipment on auction.

### CITATION LIST

### Patent Literature

Patent Literature 1: JP 2009-265745 A

### SUMMARY OF INVENTION

### Technical Problem

The auction processing device disclosed in Patent Literature 1 has a problem that, unless the equipment registered on the “purchases list” matches the equipment registered on the “favorites list”, the auction server cannot transmit, to the first user terminal, a notice prompting listing of the matching equipment for sale on auction. Therefore, even if the equipment registered on the “purchases list” includes equipment that is not currently used, the auction processing device may not prompt listing of the equipment, and thus, the transaction of the equipment that is not currently used is not promoted.

The present disclosure has been made to solve the above problems, and an object of the present disclosure is to obtain an equipment management server capable of prompting listing of equipment registered on a “purchases list” for sale on a secondhand products trading market regardless of whether or not the equipment registered on the “purchases list” matches equipment registered on the “favorites list”.

### Solution to Problem

An equipment management server according to the present disclosure includes: processing circuitry to perform a process to: acquire, from a first terminal device in which equipment owned by a user is registered, equipment information indicating the equipment; acquire a transaction result of the equipment indicated by the equipment information acquired in a secondhand products trading market, and determine whether or not there is a demand for the equipment in the secondhand products trading market on a basis of the transaction result; and transmit, to the first terminal device, a listing solicitation notice prompting listing of the equipment on the secondhand products trading market when the process determines that there is a demand.

### Advantageous Effects of Invention

According to the present disclosure, listing of the equipment registered on a “purchases list” on the secondhand products trading market is prompted, regardless of whether or not the equipment registered on the “purchases list” matches equipment registered on the “favorites list”.

### BRIEF DESCRIPTION OF DRAWINGS

FIG. 1 is a configuration diagram illustrating an information processing system 1 according to a first embodiment.

FIG. 2 is a configuration diagram illustrating a first terminal device 14 according to the first embodiment.

FIG. 3 is a hardware configuration diagram illustrating hardware of the first terminal device 14 according to the first embodiment.

FIG. 4 is a hardware configuration diagram of a computer in a case where the first terminal device 14 is implemented by software, firmware, or the like.

FIG. 5 is a configuration diagram illustrating an equipment management server 19 according to the first embodiment.

FIG. 6 is a hardware configuration diagram illustrating hardware of the equipment management server 19 according to the first embodiment.

FIG. 7 is a hardware configuration diagram of a computer in a case where the equipment management server 19 is implemented by software, firmware, or the like.

FIG. 8A is a time chart illustrating main parts of procedures of processing performed by the first terminal device 14, a second terminal device 18, and the equipment management server 19, respectively.

FIG. 8B is a time chart illustrating main parts of the procedures of processing performed by the first terminal device 14, the second terminal device 18, and the equipment management server 19, respectively.

FIG. 9A is a flowchart illustrating an information processing method which is a procedure of processing performed by the equipment management server 19 according to the first embodiment.

FIG. 9B is a flowchart illustrating the information processing method which is a procedure of processing performed by the equipment management server 19 according to the first embodiment.

FIG. 10 is an explanatory diagram illustrating an example of a “purchases list” corresponding to a first user who owns equipment 11-n.

FIG. 11 is an explanatory diagram illustrating an example of a “favorites list” corresponding to a second user.

FIG. 12 is an explanatory diagram illustrating an example of a list of equipment.

FIG. 13 is an explanatory diagram illustrating an example of an instruction manual of the equipment 11-n.

FIG. 14 is an explanatory diagram illustrating an example of a listing solicitation image.

FIG. 15 is an explanatory diagram illustrating an example of an image indicating both a recommended listing price and equipment attribute information.

FIG. 16 is an explanatory diagram illustrating an example of an image indicating a listing notice.

FIG. 17 is an explanatory diagram illustrating an example of an image indicating that there is a prospective purchaser.

FIG. 18 is an explanatory diagram illustrating an example of an image indicating establishment of transaction.

FIG. 19 is a configuration diagram illustrating a first terminal device 14 according to a second embodiment.

FIG. 20 is a hardware configuration diagram illustrating hardware of the first terminal device 14 according to the second embodiment.

FIG. 21 is a configuration diagram illustrating an equipment management server 19 according to the second embodiment.

FIG. 22 is a hardware configuration diagram illustrating hardware of the equipment management server 19 according to the second embodiment.

FIG. 23 is a time chart illustrating main parts of the procedures of processing performed by the first terminal device 14, a second terminal device 18, and the equipment management server 19, respectively.

FIG. 24 is an explanatory diagram illustrating an example of an image indicating a purchase offer.

FIG. 25 is an explanatory diagram illustrating an example of a notice list image.

FIG. 26A is an explanatory diagram illustrating an example of a list of equipment, and FIG. 26B is an explanatory diagram illustrating information regarding equipment that has been purchased and is owned now.

FIG. 27A is an explanatory diagram illustrating an example of a list of equipment, and FIG. 27B is an explanatory diagram illustrating information of any one of equipment 11-1 to 11-N included in the “favorites list”.

FIG. 28 is an explanatory diagram illustrating an example of an image indicating a listing notice.

FIG. 29 is a configuration diagram illustrating a product management server 19′.

FIG. 30 is a configuration diagram illustrating the product management server 19′.

FIG. 31 is a configuration diagram illustrating a first terminal device 14′.

FIG. 32 is a configuration diagram illustrating the first terminal device 14′.

### DESCRIPTION OF EMBODIMENTS

In order to describe the present disclosure in more detail, a mode for carrying out the present disclosure will now be described with reference to the accompanying drawings.

### First Embodiment

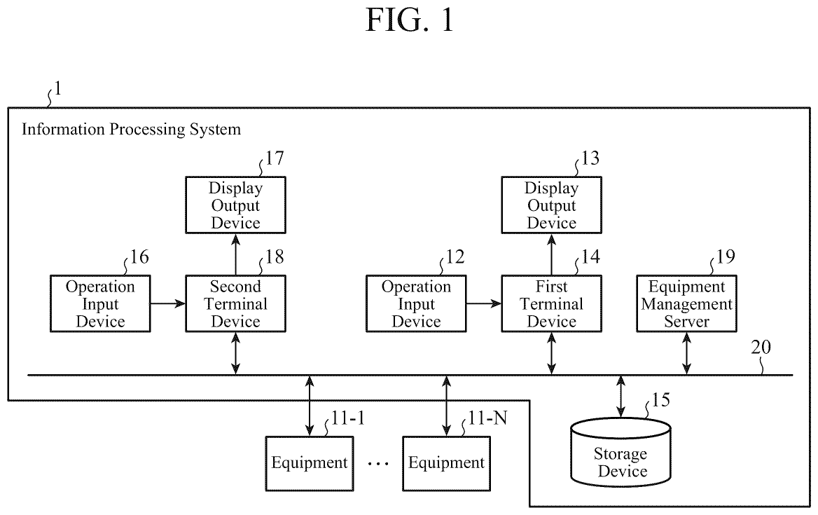

FIG. 1 is a configuration diagram illustrating an information processing system 1 according to a first embodiment.

The information processing system 1 illustrated in FIG. 1 includes an operation input device 12, a display output device 13, a first terminal device 14, a storage device 15, an operation input device 16, a display output device 17, a second terminal device 18, an equipment management server 19, and a network 20.

The information processing system 1 illustrated in FIG. 1 handles not only a business to consumer (B to C) transaction such as an auction but also a customer to customer (C to C) transaction such as a flea market, for example.

Conventionally, there is an application or the like that registers equipment owned by a user or equipment that the user is interested in for a purpose different from a purpose of stimulating a secondhand products market. If the function of the information processing system 1 illustrated in FIG. 1 can be applied to the above application or the like, there is a potential to stimulate the secondhand products trading market including not only an apparent user who is interested in transactions of secondhand products but also a potential user who is not interested in transactions of secondhand products.

Note that, although an auction or a flea market generally focuses on transactions of secondhand products, it may include transactions of brand-new products.

Equipment 11-n (n=1, . . . , N) is a tangible object owned by the user and does not include electronic data stored in a storage medium. The tangible object includes, in addition to home electric appliances, residential equipment items, in-vehicle equipment, factory automation (FA) equipment, building equipment items, restaurant equipment, and the like. N is an integer equal to or greater than 1.

FIG. 1 illustrates an example in which, in the information processing system 1, all equipment 11-1 to 11-N are connected to the network 20. However, the equipment 11-n connected to the network 20 is an IoT device, and the equipment 11-n that is a non-IoT device is not connected to the network 20.

The operation input devices 12 and 16 are implemented by a keyboard, a mouse, a gesture operation recognizing device, or a man-machine interface device such as a touch panel.

The operation input device 12 receives an operation of the first user (hereinafter referred to as “first user operation”) and outputs operation information indicating the content of the first user operation to the first terminal device 14.

The operation input device 16 receives an operation of the second user (hereinafter referred to as “second user operation”) and outputs operation information indicating the content of the second user operation to the second terminal device 18.

In the information processing system 1 illustrated in FIG. 1, the operation input devices 12 and 16 are implemented by a keyboard, a mouse, a gesture operation recognizing device, or a touch panel. However, this is merely an example, and the operation input devices 12 and 16 may be implemented by, for example, a voice input device including a microphone that takes in the voice of the user and a voice operation analyzing unit that converts the voice taken in by the microphone into an electric signal and generates operation information from the electric signal.

The display output devices 13 and 17 include a liquid crystal display, an organic electro luminescence (EL) display, or the like.

The display output device 13 displays an image indicated by display data output from the first terminal device 14 on a liquid crystal display or the like.

The display output device 17 displays an image indicated by display data output from the second terminal device 18 on a liquid crystal display or the like.

The storage device 15 includes a storage medium such as a solid state drive (SSD) or a hard disk drive (HDD). The storage device 15 performs a process of writing information into a storage medium in accordance with an external request to write information, and performs a process of reading information stored in the storage medium in accordance with an external request to read information.

Each of the first terminal device 14 and the second terminal device 18 is implemented by a general-purpose computer such as a personal computer, a mobile terminal such as a smartphone or a tablet terminal, a dedicated integrated circuit, or the like.

FIG. 1 illustrates an example in which, in the information processing system 1, the operation input device 12 and the display output device 13 are provided outside the first terminal device 14, and the operation input device 16 and the display output device 17 are provided outside the second terminal device 18. It is to be noted, however, that, in a case where the first terminal device 14 is implemented by a mobile terminal, the operation input device 12 and the display output device 13 may be provided inside the first terminal device 14. In addition, in a case where the second terminal device 18 is implemented by a mobile terminal, the operation input device 16 and the display output device 17 may be provided inside the second terminal device 18.

The equipment management server 19 is implemented by a general-purpose computer such as a personal computer, a dedicated integrated circuit, or the like.

The first terminal device 14 and the second terminal device 18 can transmit and receive information to and from the equipment management server 19 via the network 20.

In the information processing system 1 illustrated in FIG. 1, the storage device 15 is provided outside the equipment management server 19. However, this is merely an example, and the storage device 15 may be provided inside the equipment management server 19.

The network 20 is a communication network such as a local area network (LAN), a wireless LAN, long term evolution (LTE), 4th generation (4G), 5G, or an Internet line.

The equipment 11-n (n=1, . . . , N), the first terminal device 14, the storage device 15, the second terminal device 18, and the equipment management server 19 are connected to the network 20.

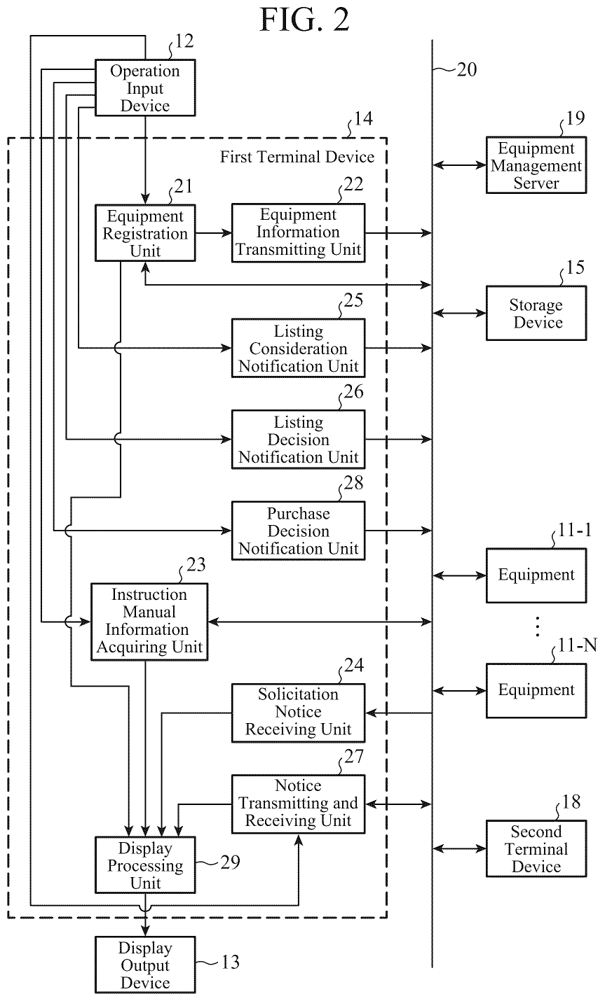

FIG. 2 is a configuration diagram illustrating the first terminal device 14 according to the first embodiment.

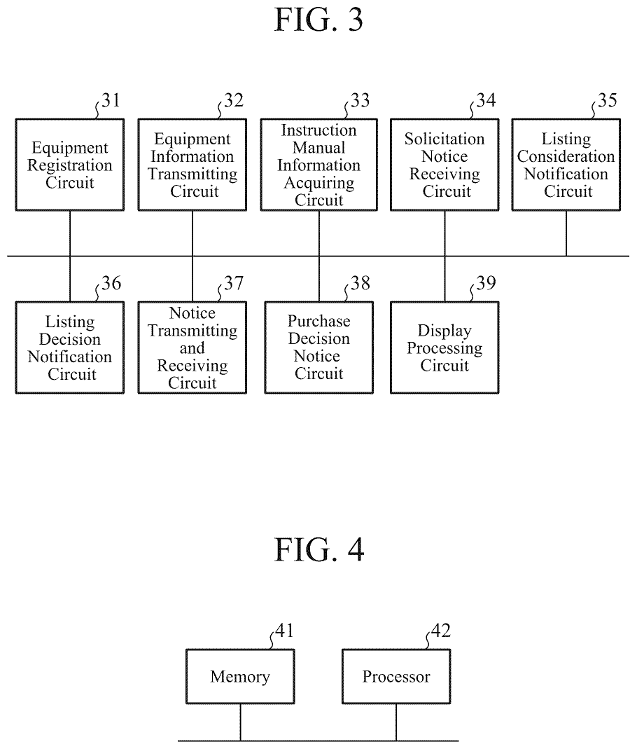

FIG. 3 is a hardware configuration diagram illustrating hardware of the first terminal device 14 according to the first embodiment.

The first terminal device 14 illustrated in FIG. 2 includes an equipment registration unit 21, an equipment information transmitting unit 22, an instruction manual information acquiring unit 23, a solicitation notice receiving unit 24, a listing consideration notification unit 25, a listing decision notification unit 26, a notice transmitting and receiving unit 27, a purchase decision notification unit 28, and a display processing unit 29.

The configuration of the second terminal device 18 is similar to the configuration of the first terminal device 14, and FIG. 2 is applied as a configuration diagram illustrating the configuration of the second terminal device 18.

It is to be noted that, in the second terminal device 18, the operation input device connected to the second terminal device 18 is the operation input device 16, and the display output device connected to the second terminal device 18 is the display output device 17.

The equipment registration unit 21 is implemented by, for example, an equipment registration circuit 31.

The equipment registration unit 21 acquires equipment information indicating the equipment 11-n (n=1, . . . , N) owned by the first user from the operation input device 12.

The equipment registration unit 21 registers the equipment 11-n by adding the equipment information to a “purchases list” to be described later. The “purchases list” may be stored in, for example, the storage device 15, or may be stored in an external storage device (not illustrated). The “purchases list” may be stored in an internal memory of the equipment registration unit 21.

In the first terminal device 14 illustrated in FIG. 2, the equipment registration unit 21 acquires equipment information from the operation input device 12. However, this is merely an example, and in a case where, for example, a barcode indicating equipment information is affixed to the equipment 11-n, a barcode reader (not illustrated) may read the barcode, and the equipment registration unit 21 may acquire the equipment information indicated by the barcode read by the barcode reader. In addition, the equipment registration unit 21 may acquire the equipment information from a purchase history remaining in a sales site from which the equipment 11-n has been purchased. Furthermore, a camera (not illustrated) may capture an image of a character string of an equipment model number which is equipment information described in a housing of the equipment 11-n, a packing box of the equipment 11-n, an instruction manual of the equipment 11-n, or the like, and optical character recognition (OCR) may acquire the equipment information from the image captured by the camera.

The equipment information transmitting unit 22 is implemented by, for example, an equipment information transmitting circuit 32.

The equipment information transmitting unit 22 transmits equipment information indicating the equipment 11-n (n=1, . . . , N) owned by the first user to the equipment management server 19 via the network 20.

The instruction manual information acquiring unit 23 is implemented by, for example, an instruction manual information acquiring circuit 33.

When receiving an acquisition request to acquire an instruction manual including equipment information indicating the equipment 11-n from the operation input device 12, the instruction manual information acquiring unit 23 transmits the acquisition request to acquire the instruction manual to the equipment management server 19 via the network 20.

The instruction manual information acquiring unit 23 receives instruction manual data indicating the instruction manual of the equipment 11-n from the equipment management server 19 via the network 20.

The instruction manual information acquiring unit 23 outputs the instruction manual data to the display processing unit 29.

The solicitation notice receiving unit 24 is implemented by, for example, a solicitation notice receiving circuit 34.

The solicitation notice receiving unit 24 receives a listing solicitation notice prompting listing of the equipment (11-n) for sale on a secondhand products trading market from the equipment management server 19 via the network 20.

The solicitation notice receiving unit 24 outputs a listing solicitation notice to the display processing unit 29.

In addition, the solicitation notice receiving unit 24 receives a recommended listing price of the equipment 11-n from the equipment management server 19 via the network 20.

The solicitation notice receiving unit 24 outputs the recommended listing price to the display processing unit 29.

The listing consideration notification unit 25 is implemented by, for example, a listing consideration notification circuit 35.

When the operation input device 12 receives an operation indicating an intention of “considering listing of the equipment 11-n on the secondhand products trading market” as the first user operation, the listing consideration notification unit 25 transmits a listing consideration notice indicating that the listing of the equipment 11-n is considered to the equipment management server 19 via the network 20.

The listing decision notification unit 26 is implemented by, for example, a listing decision notification circuit 36.

When the operation input device 12 receives an operation indicating an intention of “listing the equipment 11-n for sale on the secondhand products trading market” as the first user operation, the listing decision notification unit 26 transmits a listing decision notice indicating that the equipment 11-n is to be listed on the secondhand products trading market to the equipment management server 19 via the network 20.

The notice transmitting and receiving unit 27 is implemented by, for example, a notice transmitting and receiving circuit 37.

When receiving a listing notice indicating that the equipment 11-n is listed on the secondhand products trading market from the equipment management server 19 via the network 20, the notice transmitting and receiving unit 27 of the second terminal device 18 outputs the listing notice to the display processing unit 29.

When receiving, from the equipment management server 19 via the network 20, a prospective-purchaser presence notice indicating that there is a prospective purchaser, the notice transmitting and receiving unit 27 of the first terminal device 14 outputs the prospective-purchaser presence notice to the display processing unit 29.

In addition, when receiving an equipment purchase notice indicating an intention of purchasing the equipment 11-n from the equipment management server 19 via the network 20, the notice transmitting and receiving unit 27 of the first terminal device 14 outputs the equipment purchase notice to the display processing unit 29.

When the operation input device 12 receives an operation indicating an intention of “selling the equipment 11-n” as the first user operation, the notice transmitting and receiving unit 27 of the first terminal device 14 transmits an equipment sale decision notice indicating an intention of selling the equipment 11-n to the equipment management server 19 via the network 20.

When receiving a transaction establishment notice indicating that the transaction for the equipment 11-n is established from the equipment management server 19 via the network 20, the notice transmitting and receiving unit 27 of the second terminal device 18 outputs the transaction establishment notice to the display processing unit 29.

The purchase decision notification unit 28 is implemented by, for example, a purchase decision notification circuit 38.

When the operation input device 16 receives an operation indicating an intention of “purchasing the equipment 11-n” as the second user operation, the purchase decision notification unit 28 of the second terminal device 18 transmits an equipment purchase notice indicating an intention of purchasing the equipment 11-n to the equipment management server 19 via the network 20.

The display processing unit 29 is implemented by, for example, a display processing circuit 39.

The display processing unit 29 of the first terminal device 14 acquires instruction manual data from the instruction manual information acquiring unit 23, and generates display data indicating the instruction manual of the equipment 11-n.

The display processing unit 29 of the first terminal device 14 outputs the display data to the display output device 13 so as to display the instruction manual of the equipment 11-n on the display of the display output device 13.

In addition, the display processing unit 29 of the first terminal device 14 acquires the listing solicitation notice from the solicitation notice receiving unit 24, and generates display data of a listing solicitation image indicating that the equipment 11-n is prompted to be listed on the secondhand products trading market.

The display processing unit 29 of the first terminal device 14 outputs the display data to the display output device 13 so as to display the listing solicitation image on the display of the display output device 13.

The display processing unit 29 of the first terminal device 14 acquires the recommended listing price from the solicitation notice receiving unit 24 and generates display data of an image indicating the recommended listing price.

The display processing unit 29 of the first terminal device 14 outputs the display data to the display output device 13 so as to display the image indicating the recommended listing price on the display of the display output device 13.

The display processing unit 29 of the first terminal device 14 acquires the prospective-purchaser presence notice from the notice transmitting and receiving unit 27, and generates display data of a prospective-purchaser presence image indicating that there is a prospective purchaser.

The display processing unit 29 of the first terminal device 14 outputs the display data to the display output device 13 so as to display the prospective-purchaser presence image on the display of the display output device 13.

The display processing unit 29 of the second terminal device 18 acquires the listing notice from the notice transmitting and receiving unit 27 and generates display data of an image indicating the listing notice.

The display processing unit 29 of the second terminal device 18 outputs the display data to the display output device 17 so as to display the image indicating the listing notice on the display of the display output device 17.

The display processing unit 29 of the second terminal device 18 acquires the transaction establishment notice from the notice transmitting and receiving unit 27 and generates display data of an image indicating the establishment of the transaction.

The display processing unit 29 of the second terminal device 18 outputs the display data to the display output device 17 so as to display the image indicating the establishment of the transaction on the display of the display output device 17.

In FIG. 2, it is assumed that each of the equipment registration unit 21, the equipment information transmitting unit 22, the instruction manual information acquiring unit 23, the solicitation notice receiving unit 24, the listing consideration notification unit 25, the listing decision notification unit 26, the notice transmitting and receiving unit 27, the purchase decision notification unit 28, and the display processing unit 29, which are components of the first terminal device 14, is implemented by dedicated hardware as illustrated in FIG. 3. That is, it is assumed that the first terminal device 14 is implemented by the equipment registration circuit 31, the equipment information transmitting circuit 32, the instruction manual information acquiring circuit 33, the solicitation notice receiving circuit 34, the listing consideration notification circuit 35, the listing decision notification circuit 36, the notice transmitting and receiving circuit 37, the purchase decision notification circuit 38, and the display processing circuit 39.

Each of the equipment registration circuit 31, the equipment information transmitting circuit 32, the instruction manual information acquiring circuit 33, the solicitation notice receiving circuit 34, the listing consideration notification circuit 35, the listing decision notification circuit 36, the notice transmitting and receiving circuit 37, the purchase decision notification circuit 38, and the display processing circuit 39 is, for example, a single circuit, a composite circuit, a programmed processor, a parallel programmed processor, an application specific integrated circuit (ASIC), a field-programmable gate array (FPGA), or a combination of some of these circuits.

The components of the first terminal device 14 are not limited to be implemented by dedicated hardware, and the first terminal device 14 may be implemented by software, firmware, or a combination of software and firmware.

Software or firmware is stored in a memory of a computer as a program. The computer means hardware that executes the program, and may be, for example, a central processing unit (CPU), central processor, processing unit, computing unit, microprocessor, microcomputer, processor, or digital signal processor (DSP).

FIG. 4 is a hardware configuration diagram of a computer in a case where the first terminal device 14 is implemented by software, firmware, or the like.

In a case where the first terminal device 14 is implemented by software, firmware, or the like, an image display program for causing the computer to execute respective processing procedures performed by the equipment registration unit 21, the equipment information transmitting unit 22, the instruction manual information acquiring unit 23, the solicitation notice receiving unit 24, the listing consideration notification unit 25, the listing decision notification unit 26, the notice transmitting and receiving unit 27, the purchase decision notification unit 28, and the display processing unit 29 is stored in a memory 41. Then, a processor 42 of the computer executes the image display program stored in the memory 41.

Further, FIG. 3 shows an example in which each of the components of the first terminal device 14 is implemented by dedicated hardware, and FIG. 4 shows an example in which the first terminal device 14 is implemented by software, firmware, or the like. However, this is merely an example, and some components in the first terminal device 14 may be implemented by dedicated hardware, and the remaining components may be implemented by software, firmware, or the like.

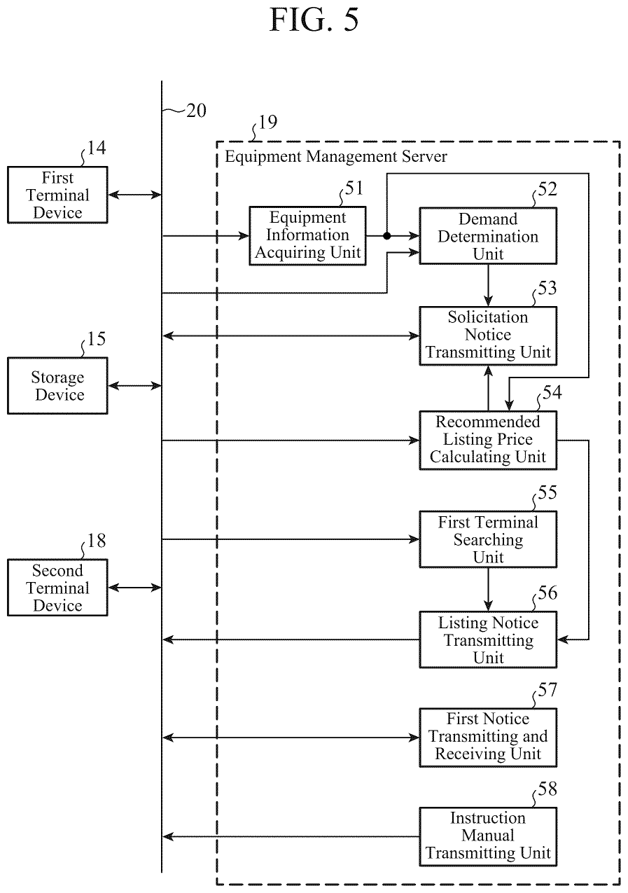

FIG. 5 is a configuration diagram illustrating the equipment management server 19 according to the first embodiment.

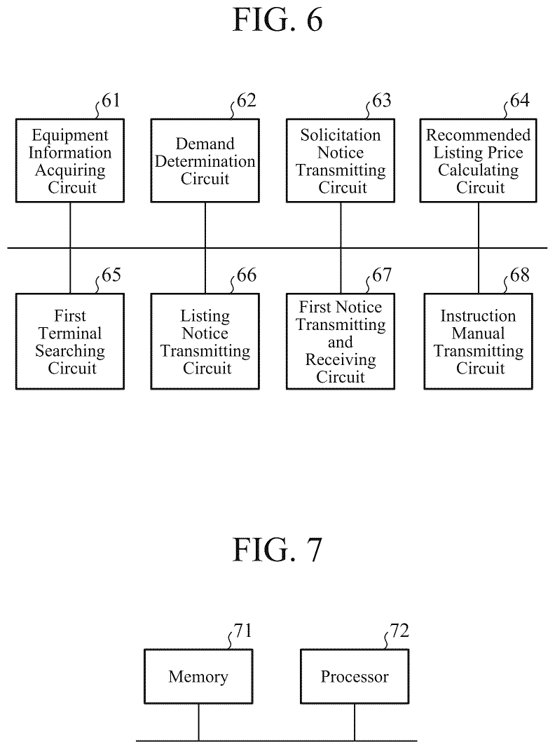

FIG. 6 is a hardware configuration diagram illustrating hardware of the equipment management server 19 according to the first embodiment.

The equipment management server 19 illustrated in FIG. 5 includes an equipment information acquiring unit 51, a demand determination unit 52, a solicitation notice transmitting unit 53, a recommended listing price calculating unit 54, a first terminal searching unit 55, a listing notice transmitting unit 56, a first notice transmitting and receiving unit 57, and an instruction manual transmitting unit 58.

The equipment information acquiring unit 51 is implemented by, for example, an equipment information acquiring circuit 61 illustrated in FIG. 6.

The equipment information acquiring unit 51 acquires the equipment information indicating the equipment 11-n from the first terminal device 14 that has registered the equipment 11-n owned by the first user via the network 20.

The equipment information acquiring unit 51 outputs the equipment information to each of the demand determination unit 52 and the recommended listing price calculating unit 54.

The demand determination unit 52 is implemented by, for example, a demand determination circuit 62 illustrated in FIG. 6.

The demand determination unit 52 acquires the equipment information output from the equipment information acquiring unit 51.

The demand determination unit 52 acquires the number of past transactions in the secondhand products trading market from the storage device 15 as transaction results of the equipment 11-n indicated by the equipment information in the secondhand products trading market.

In the information processing system 1 illustrated in FIG. 1, it is assumed that the storage device 15 stores the number of transactions of the equipment 11-n, and the demand determination unit 52 acquires the number of transactions of the equipment 11-n from the storage device 15. However, this is merely an example, and in a case where an external server (not illustrated) stores the number of transactions of the equipment 11-n, the demand determination unit 52 may acquire the number of transactions of the equipment 11-n from the external server.

The demand determination unit 52 determines whether or not there is a demand for the equipment 11-n in the secondhand products trading market on the basis of the number of transactions of the equipment 11-n in the secondhand products trading market indicated by the equipment information acquired by the equipment information acquiring unit 51.

That is, the demand determination unit 52 determines that there is a demand for the equipment 11-n in the secondhand products trading market when the number of transactions of the equipment 11-n in the secondhand products trading market tends to increase or the number of transactions of the equipment 11-n in the secondhand products trading market is equal to or larger than a threshold. The threshold may be stored in an internal memory of the demand determination unit 52 or may be given from the outside of the equipment management server 19.

The demand determination unit 52 outputs a determination result indicating whether or not there is a demand to the solicitation notice transmitting unit 53.

In the equipment management server 19 illustrated in FIG. 5, the demand determination unit 52 acquires the number of transactions as the transaction results of the equipment 11-n in the secondhand products trading market, and determines whether or not there is a demand for the equipment 11-n in the secondhand products trading market on the basis of the number of transactions. However, this is merely an example, and the demand determination unit 52 may acquire the contract rate after listing of the equipment 11-n, the average contract price of the equipment 11-n, the average number of days required for the contract of the equipment 11-n, or the like as the transaction results of the equipment 11-n in the secondhand products trading market, and determine whether or not there is a demand for the equipment 11-n in the secondhand products trading market on the basis of the acquired transaction results.

The solicitation notice transmitting unit 53 is implemented by, for example, a solicitation notice transmitting circuit 63 illustrated in FIG. 6.

The solicitation notice transmitting unit 53 acquires the determination result from the demand determination unit 52.

When the demand determination unit 52 determines that there is a demand, the solicitation notice transmitting unit 53 transmits a listing solicitation notice that prompts listing of the equipment 11-n for sale on the secondhand products trading market to the first terminal device 14 via the network 20. In addition, the solicitation notice transmitting unit 53 transmits the representative value of the transaction price calculated by the recommended listing price calculating unit 54 to the first terminal device 14 via the network 20.

When receiving a listing consideration notice indicating that listing of the equipment 11-n on the secondhand products trading market is considered from the first terminal device 14 via the network 20, the solicitation notice transmitting unit 53 transmits the recommended listing price calculated by the recommended listing price calculating unit 54 to the first terminal device 14 via the network 20.

In the equipment management server 19 illustrated in FIG. 5, the solicitation notice transmitting unit 53 transmits the recommended listing price to the first terminal device 14. When transmitting the recommended listing price to the first terminal device 14, the solicitation notice transmitting unit 53 may transmit advice regarding the recommended listing timing to the first terminal device 14. Examples of the conceivable recommended listing timing include “The prices of secondhand similar equipment in the same category tend to decrease sharply after one year has passed since production, and thus, I think it is better to sell it before that.” and “The national total number of people who register the equipment 11-n in “favorites list” has changed from an increasing trend to a decreasing trend, and thus, I think it is better to sell it earlier.”

The recommended listing price calculating unit 54 is implemented by, for example, a recommended listing price calculating circuit 64 illustrated in FIG. 6.

When receiving the equipment information from the equipment information acquiring unit 51, the recommended listing price calculating unit 54 acquires the past transaction prices of the equipment 11-n indicated by the equipment information in the secondhand products trading market from the storage device 15.

In the information processing system 1 illustrated in FIG. 1, it is assumed that the storage device 15 stores the transaction prices of the equipment 11-n, and the recommended listing price calculating unit 54 acquires the transaction prices of the equipment 11-n from the storage device 15. However, this is merely an example, and in a case where an external server (not illustrated) stores the transaction prices of the equipment 11-n, the recommended listing price calculating unit 54 may acquire the transaction prices of the equipment 11-n from the external server.

The recommended listing price calculating unit 54 calculates an average value of the transaction prices as a representative value of the transaction prices of the equipment 11-n in the secondhand products trading market.

The recommended listing price calculating unit 54 outputs the average value of the transaction prices to the solicitation notice transmitting unit 53.

When receiving the listing consideration notice from the first terminal device 14 via the network 20, the recommended listing price calculating unit 54 calculates the recommended listing price on the basis of the average value of the transaction prices.

When calculating the recommended listing price on the basis of the average value of the transaction prices, the recommended listing price calculating unit 54 may calculate the recommended listing price using one or more of the usage condition of the equipment 11-n indicated by the equipment information and a warranty status of the equipment 11-n.

The recommended listing price calculating unit 54 outputs the recommended listing price to each of the solicitation notice transmitting unit 53 and the listing notice transmitting unit 56.

In the equipment management server 19 illustrated in FIG. 5, the recommended listing price calculating unit 54 calculates the average value of the transaction prices as the representative value of the transaction prices of the equipment 11-n, and calculates the recommended listing price on the basis of the average value of the transaction prices. However, this is merely an example, and the recommended listing price calculating unit 54 may calculate the median, the weighted average, the mode, the lower limit, the upper limit, or the price range from the lower limit to the upper limit of the transaction price as the representative value of the transaction prices of the equipment 11-n, and calculate the recommended listing price on the basis of the calculated representative value.

The first terminal searching unit 55 is implemented by, for example, a first terminal searching circuit 65 illustrated in FIG. 6.

When receiving a listing consideration notice indicating that the listing of the equipment 11-n is considered from the first terminal device 14 via the network 20, the first terminal searching unit 55 searches for the second terminal device 18 owned by the second user who is likely to purchase the equipment 11-n. One or more second terminal devices 18 owned by the second user who is likely to purchase the equipment 11-n may be present. In a case where there is a plurality of second terminal devices 18, the first terminal searching unit 55 searches for a plurality of second terminal devices 18. Note that it is assumed that there are often multiple second terminal devices 18, rather than only one, of the second user who is likely to purchase the equipment 11-n.

The first terminal searching unit 55 outputs a search result of the second terminal device 18 to the listing notice transmitting unit 56.

The listing notice transmitting unit 56 is implemented by, for example, a listing notice transmitting circuit 66 illustrated in FIG. 6.

The listing notice transmitting unit 56 acquires the search result of the second terminal device 18 from the first terminal searching unit 55.

While the first terminal searching unit 55 receives the listing decision notice from the first terminal device 14, the listing notice transmitting unit 56 transmits the listing notice indicating that the equipment 11-n has been listed on the secondhand products trading market to the second terminal device 18 searched by the first terminal searching unit 55 via the network 20.

The listing notice transmitting unit 56 adds, to the listing notice transmitted by the listing notice transmitting unit 56, one or more of a profile of the first user who lists the equipment 11-n for sale on the secondhand products trading market and transaction results of the first user in the secondhand products trading market, for example.

In a case where a plurality of second terminal devices 18 is searched by the first terminal searching unit 55, the listing notice transmitting unit 56 transmits the listing notice to each of the plurality of second terminal devices 18 via the network 20.

The first notice transmitting and receiving unit 57 is implemented by, for example, a first notice transmitting and receiving circuit 67 illustrated in FIG. 6.

When receiving an equipment purchase notice indicating an intention to purchase the equipment 11-n from the second terminal device 18 via the network 20, the first notice transmitting and receiving unit 57 transfers a prospective-purchaser presence notice indicating that there is a prospective purchaser to the first terminal device 14 via the network 20.

When receiving an equipment sale decision notice indicating an intention to sell the equipment 11-n from the first terminal device 14 via the network 20, the first notice transmitting and receiving unit 57 transmits a transaction establishment notice indicating that the transaction of the equipment 11-n has been established to the second terminal device 18 via the network 20.

The instruction manual transmitting unit 58 is implemented by, for example, an instruction manual transmitting circuit 68 illustrated in FIG. 6

The instruction manual transmitting unit 58 receives an acquisition request to acquire an instruction manual from the first terminal device 14 via the network 20.

The instruction manual transmitting unit 58 transfers the equipment information included in the acquisition request to acquire the instruction manual to, for example, a server of a manufacturer of the equipment 11-n indicated by the equipment information via the network 20, thereby collecting the instruction manual data indicating the instruction manual of the equipment 11-n from the server of the manufacturer.

The instruction manual transmitting unit 58 transmits the instruction manual data to the first terminal device 14 via the network 20.

In the information processing system 1 illustrated in FIG. 1, the instruction manual transmitting unit 58 collects instruction manual data indicating the instruction manual of the equipment 11-n from the server of the manufacturer. However, this is merely an example, and in a case where, for example, the storage device 15 stores the instruction manual data indicating the instruction manual of the equipment 11-n in advance, the instruction manual transmitting unit 58 may transfer the equipment information included in the acquisition request to the storage device 15 to collect the instruction manual data indicating the instruction manual of the equipment 11-n from the storage device 15.

In FIG. 5, it is assumed that each of the equipment information acquiring unit 51, the demand determination unit 52, the solicitation notice transmitting unit 53, the recommended listing price calculating unit 54, the first terminal searching unit 55, the listing notice transmitting unit 56, the first notice transmitting and receiving unit 57, and the instruction manual transmitting unit 58, which are components of the equipment management server 19 is implemented by dedicated hardware as illustrated in FIG. 6. That is, it is assumed that the equipment management server 19 is implemented by the equipment information acquiring circuit 61, the demand determination circuit 62, the solicitation notice transmitting circuit 63, the recommended listing price calculating circuit 64, the first terminal searching circuit 65, the listing notice transmitting circuit 66, the first notice transmitting and receiving circuit 67, and the instruction manual transmitting circuit 68.

Here, each of the equipment information acquiring circuit 61, the demand determination circuit 62, the solicitation notice transmitting circuit 63, the recommended listing price calculating circuit 64, the first terminal searching circuit 65, the listing notice transmitting circuit 66, the first notice transmitting and receiving circuit 67, and the instruction manual transmitting circuit 68 is, for example, a single circuit, a composite circuit, a programmed processor, a parallel programmed processor, an ASIC, an FPGA, or a combination of some of these circuits.

The components of the equipment management server 19 are not limited to be implemented by dedicated hardware, and the equipment management server 19 may be implemented by software, firmware, or a combination of software and firmware.

FIG. 7 is a hardware configuration diagram of a computer in a case where the equipment management server 19 is implemented by software, firmware, or the like.

In a case where the equipment management server 19 is implemented by software, firmware, or the like, an information processing program for causing the computer to execute respective processing procedures performed by the equipment information acquiring unit 51, the demand determination unit 52, the solicitation notice transmitting unit 53, the recommended listing price calculating unit 54, the first terminal searching unit 55, the listing notice transmitting unit 56, the first notice transmitting and receiving unit 57, and the instruction manual transmitting unit 58 is stored in a memory 71. Then, a processor 72 of the computer executes the information processing program stored in the memory 71.

Further, FIG. 6 shows an example in which each of the components of the equipment management server 19 is implemented by dedicated hardware, and FIG. 7 shows an example in which the equipment management server 19 is implemented by software, firmware, or the like. However, this is merely an example, and some components in the equipment management server 19 may be implemented by dedicated hardware, and the remaining components may be implemented by software, firmware, or the like.

Next, the operation of the information processing system 1 illustrated in FIG. 1 will be described.

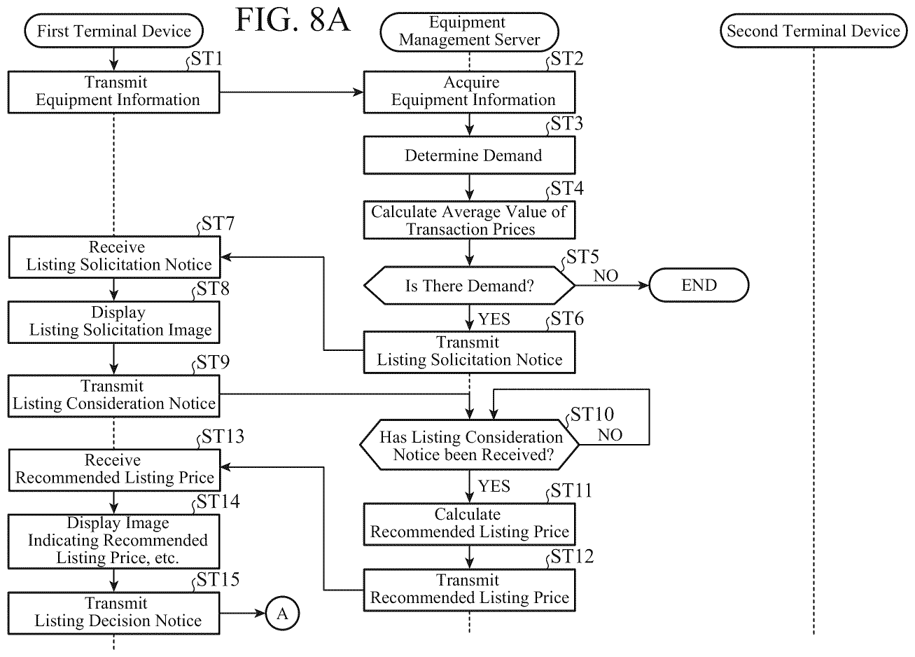

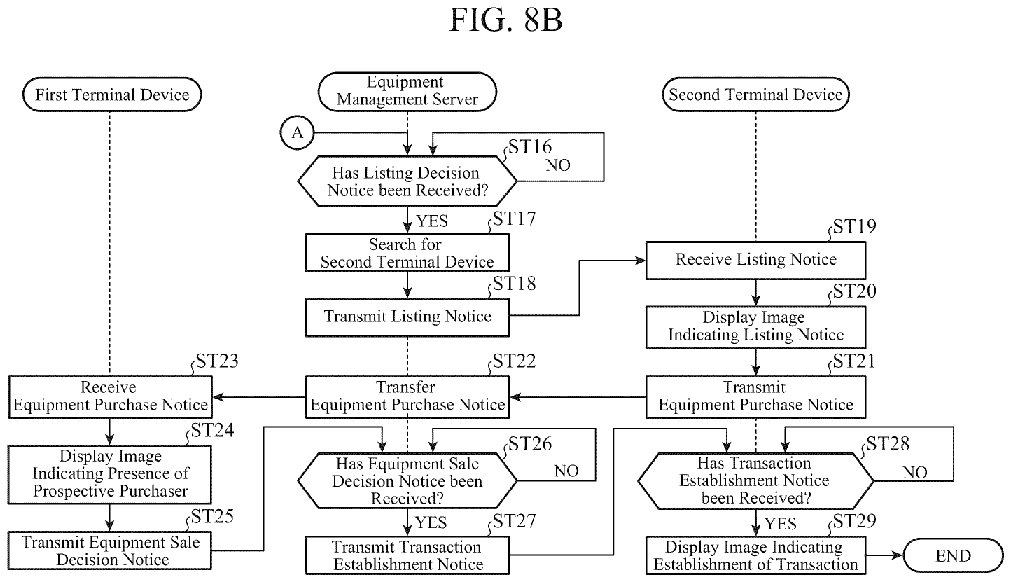

FIGS. 8A and 8B are time charts illustrating main parts of the procedures of processing performed by the first terminal device 14, the second terminal device 18, and the equipment management server 19, respectively.

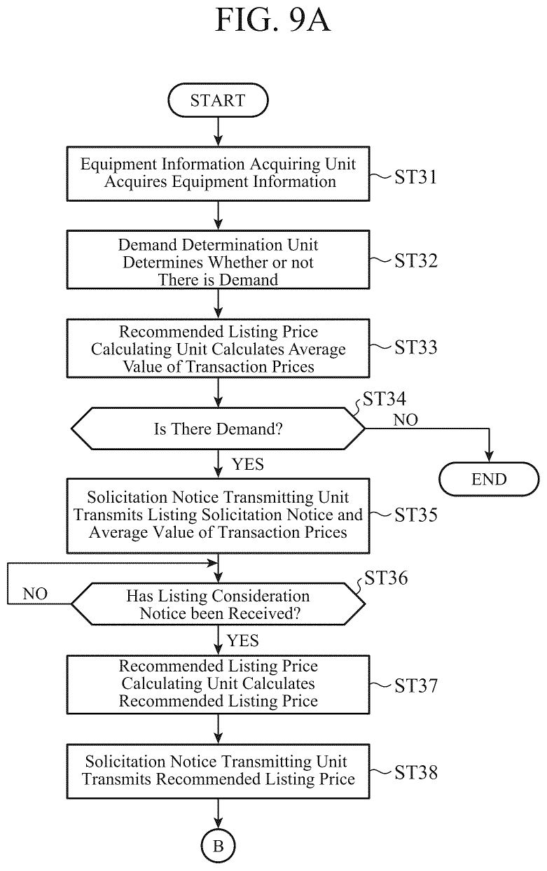

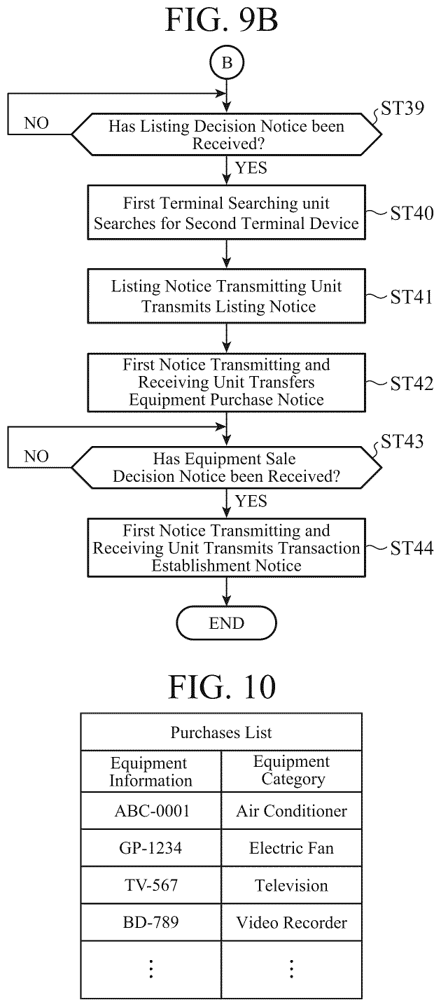

FIGS. 9A and 9B are flowcharts illustrating an information processing method which is a procedure of processing performed by the equipment management server 19 according to the first embodiment.

The operation input device 12 receives, for example, a registration operation of registering the equipment 11-n (n=1, . . . , N) owned by the first user as the first user operation.

The registration operation of registering the equipment 11-n is an operation of receiving an input of equipment information indicating the equipment 11-n.

Furthermore, the registration operation of registering the equipment 11-n is an operation of receiving an input of, for example, a user identification (ID) as user identification information for identifying the first user.

Upon receiving the input of the equipment information indicating the equipment 11-n and the user identification information, the operation input device 12 outputs an equipment registration request including the equipment information and the user identification information to the equipment registration unit 21 of the first terminal device 14.

The equipment registration unit 21 of the first terminal device 14 acquires the equipment registration request output from the operation input device 12.

The equipment registration unit 21 transmits the equipment registration request to the storage device 15 via the network 20 to register the equipment 11-n in storage device 15.

Upon receiving the equipment registration request from the equipment registration unit 21, the storage device 15 adds the equipment information included in the equipment registration request to the “purchases list” corresponding to the first user indicated by the user identification information included in the equipment registration request.

As the equipment information is added to the “purchases list”, the equipment 11-n is registered on the “purchases list” corresponding to the first user.

FIG. 10 is an explanatory diagram illustrating an example of the “purchases list” corresponding to the first user who owns the equipment 11-n.

In the example of FIG. 10, an air conditioner having equipment information of “ABC-0001”, an electric fan having equipment information of “GP-1234”, a television having equipment information of “TV-567”, and a video recorder having equipment information of “BD-789” are registered on the “purchases list”.

In the information processing system 1 illustrated in FIG. 1, the equipment registration unit 21 directly registers the equipment 11-n in the storage device 15. However, this is merely an example, and the equipment registration unit 21 may transmit the equipment registration request to the equipment management server 19 so that the equipment management server 19 registers the equipment 11-n in the storage device 15.

Note that the main purpose of the user performing the registration operation of registering the equipment 11-n (n=1, . . . , N) to register the equipment information of the equipment 11-n on the “purchases list” is assumed to centrally manage the instruction manual of the equipment 11-n, collectively purchase the extended warranty, centrally control the IoT device, or the like, rather than to list the equipment 11-n for sale on the secondhand products trading market.

The operation input device 16 receives, for example, an operation of registering the equipment of interest to the second user as the second user operation.

The operation of registering the equipment of interest is an operation of receiving an input of the equipment information of the equipment.

Furthermore, the operation of registering the equipment of interest is an operation of receiving an input of, for example, a user ID as user identification information for identifying the second user.

Upon receiving the input of the equipment information indicating the equipment of interest and the user identification information, the operation input device 16 outputs an equipment-of-interest registration request including the equipment information and the user identification information to the equipment registration unit 21 of the second terminal device 18.

The equipment registration unit 21 of the second terminal device 18 acquires the equipment-of-interest registration request output from the operation input device 16.

The equipment registration unit 21 transmits the equipment-of-interest registration request to the storage device 15 via the network 20, thereby registering the equipment of interest in the storage device 15.

Upon receiving the equipment-of-interest registration request from the equipment registration unit 21, the storage device 15 adds the equipment information included in the equipment-of-interest registration request to the “favorites list” corresponding to the second user indicated by the user identification information included in the equipment-of-interest registration request.

As the equipment information is added to the “favorites list”, the equipment of interest to the second user is registered in the “favorites list” corresponding to the second user.

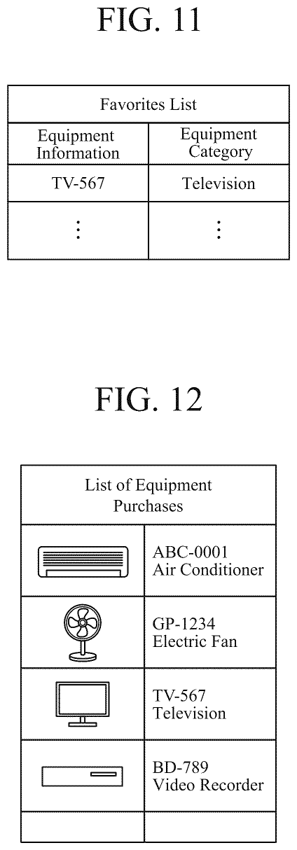

FIG. 11 is an explanatory diagram illustrating an example of the “favorites list” corresponding to the second user.

In the example of FIG. 11, a television having equipment information of “TV-567” is registered on the “favorites list”.

In the information processing system 1 illustrated in FIG. 1, the equipment registration unit 21 directly registers the equipment of interest in the storage device 15. However, this is merely an example, and the equipment registration unit 21 may transmit the equipment-of-interest registration request to the equipment management server 19 so that the equipment management server 19 registers the equipment of interest in the storage device 15.

Note that the main purpose of the user issuing the equipment-of-interest registration request to register the equipment information of the equipment of interest in the “favorites list” is generally assumed to purchase a brand-new product rather than to purchase a secondhand product in the secondhand products trading market.

The operation input device 12 receives, for example, a display operation of displaying the equipment 11-n (n=1, . . . , N) owned by the first user as the first user operation.

The display operation of displaying the equipment 11-n includes an operation of receiving an input of, for example, a user ID as user identification information for identifying the first user.

Upon receiving the display operation of displaying the equipment 11-n (n=1, . . . , N), the operation input device 12 outputs an acquisition request to acquire an equipment registration state including the user identification information to the equipment registration unit 21 of the first terminal device 14.

The equipment registration unit 21 of the first terminal device 14 acquires the acquisition request to acquire the equipment registration state output from the operation input device 12.

The equipment registration unit 21 transmits the acquisition request to acquire the equipment registration state to the storage device 15 via the network 20, thereby allowing the storage device 15 to return the equipment information included in the “purchases list” corresponding to the first user indicated by the user identification information included in the acquisition request.

Upon receiving the acquisition request to acquire the equipment registration state from the equipment registration unit 21, the storage device 15 acquires the equipment information included in the “purchases list” corresponding to the first user indicated by the user identification information included in the acquisition request.

The storage device 15 transmits the equipment information included in the “purchases list” to the equipment registration unit 21 of the first terminal device 14 via the network 20.

Upon receiving the equipment information included in the “purchases list” from the storage device 15, the equipment registration unit 21 of the first terminal device 14 transfers the equipment information included in the “purchases list” to the display processing unit 29.

Further, the equipment registration unit 21 outputs the equipment information included in the “purchases list” to the equipment information transmitting unit 22.

The display processing unit 29 of the first terminal device 14 generates display data for displaying a list of equipment indicated by the equipment information included in the “purchases list”.

The display processing unit 29 outputs the display data to the display output device 13 so as to display the list of equipment on the display of the display output device 13 as illustrated in FIG. 12.

FIG. 12 is an explanatory diagram illustrating an example of a list of equipment.

In the example of FIG. 12, an air conditioner having equipment information of “ABC-0001”, an electric fan having equipment information of “GP-1234”, a television having equipment information of “TV-567”, and a video recorder having equipment information of “BD-789” are displayed.

The operation input device 12 receives, for example, a display operation of displaying the instruction manual of the equipment 11-n owned by the first user as the first user operation.

The display operation of displaying the instruction manual of the equipment 11-n is, for example, an operation of receiving a touch on certain equipment in the list displayed on the display.

Upon receiving the display operation of displaying the instruction manual of the equipment 11-n, the operation input device 12 outputs an instruction-manual acquisition request including identification information indicating the equipment 11-n to the instruction manual information acquiring unit 23 of the first terminal device 14.

In the information processing system illustrated in FIG. 1, the operation input device 12 receives the display operation of displaying the instruction manual of the equipment 11-n owned by the first user as the first user operation. The display operation received as the first user operation by the operation input device 12 is not limited to the display operation of displaying the instruction manual of the equipment 11-n. The display operation received as the first user operation by the operation input device 12 may be any display operation of displaying information useful for the end user, and examples of the conceivable display operation include a display operation of displaying, for example, manufacturer's official FAQ (frequently asked questions and answers) related to the equipment 11-n or manufacturer's official support-related information related to the equipment 11-n.

The instruction manual information acquiring unit 23 of the first terminal device 14 transmits the instruction-manual acquisition request to the instruction manual transmitting unit 58 of the equipment management server 19 via the network 20.

The instruction manual transmitting unit 58 of the equipment management server 19 receives the instruction-manual acquisition request from the instruction manual information acquiring unit 23 of the first terminal device 14 via the network 20.

The instruction manual transmitting unit 58 transfers the equipment information included in the instruction-manual acquisition request to, for example, the server of the manufacturer of the equipment 11-n indicated by the equipment information via the network 20, thereby collecting the instruction manual data indicating the instruction manual of the equipment 11-n from the server of the manufacturer.

The instruction manual transmitting unit 58 transmits the collected instruction manual data to the instruction manual information acquiring unit 23 of the first terminal device 14 via the network 20.

The instruction manual information acquiring unit 23 of the first terminal device 14 receives the instruction manual data from the instruction manual transmitting unit 58 of the equipment management server 19 via the network 20.

The instruction manual information acquiring unit 23 outputs the instruction manual data to the display processing unit 29.

The display processing unit 29 of the first terminal device 14 generates display data for displaying the instruction manual of the equipment 11-n from the instruction manual data output from the instruction manual information acquiring unit 23.

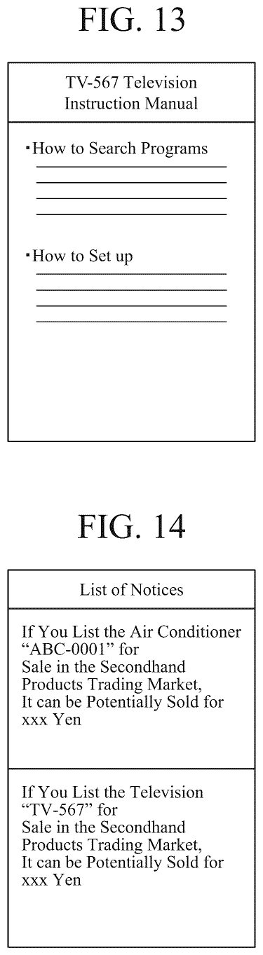

The display processing unit 29 outputs the display data to the display output device 13 so as to display the instruction manual of the equipment 11-n on the display of the display output device 13 as illustrated in FIG. 13.

FIG. 13 is an explanatory diagram illustrating an example of the instruction manual of the equipment 11-n.

In the example of FIG. 13, an instruction manual of the television “TV-567” which is the equipment 11-n is displayed.

Upon receiving the equipment information included in the “purchases list” from the equipment registration unit 21, the equipment information transmitting unit 22 of the first terminal device 14 transmits the equipment information included in the “purchases list” to the equipment information acquiring unit 51 of the equipment management server 19 via the network 20 (step ST1 in FIG. 8A).

The equipment information acquiring unit 51 of the equipment management server 19 acquires the equipment information included in the “purchases list” from the equipment information transmitting unit 22 of the first terminal device 14 via the network 20 (step ST2 in FIG. 8A and step ST31 in FIG. 9A).

The equipment information acquiring unit 51 outputs the equipment information to each of the demand determination unit 52 and the recommended listing price calculating unit 54.

The demand determination unit 52 acquires the equipment information output from the equipment information acquiring unit 51.

The demand determination unit 52 acquires the number of past transactions of the equipment 11-n indicated by the equipment information in the secondhand products trading market from the storage device 15.

As the number of past transactions in the secondhand products trading market, the number of transactions in the past month, the number of transactions in the past week, the number of transactions in the past three days, or the like can be considered.

The demand determination unit 52 determines whether or not there is a demand for the equipment 11-n in the secondhand products trading market on the basis of the number of transactions of the equipment 11-n in the secondhand products trading market indicated by the equipment information acquired by the equipment information acquiring unit 51 (step ST3 in FIG. 8A and step ST32 in FIG. 9A).

That is, the demand determination unit 52 determines that there is a demand for the equipment 11-n in the secondhand products trading market when the number of transactions of the equipment 11-n in the secondhand products trading market tends to increase or the number of transactions of the equipment 11-n in the secondhand products trading market is equal to or larger than a threshold.

For example, when the number of transactions in the past three days is acquired as the number of transactions in the secondhand products trading market, the demand determination unit 52 determines that the number of transactions tends to increase when the number of transactions in the past three days is larger than the number of transactions during the period from the past six days to the past four days.

The demand determination unit 52 outputs a determination result indicating whether or not there is a demand to the solicitation notice transmitting unit 53.

In the equipment management server 19 illustrated in FIG. 5, the demand determination unit 52 determines whether or not there is a demand for the equipment 11-n in the secondhand products trading market on the basis of the number of transactions of the equipment 11-n in the secondhand products trading market. However, this is merely an example, and the demand determination unit 52 may determine whether or not there is a demand for the equipment 11-n in the secondhand products trading market on the basis of transaction results other than the number of transactions of the equipment 11-n in the secondhand products trading market.

When determining whether or not there is a demand for the equipment 11-n in the secondhand products trading market on the basis of, for example, the contract rate after listing of the equipment 11-n as the transaction results other than the number of transactions, the demand determination unit 52 determines whether or not there is a demand for the equipment 11-n in the secondhand products trading market as follows, for example.

The demand determination unit 52 determines that there is a demand for the equipment 11-n in the secondhand products trading market when the contract rate after listing of the equipment 11-n on the secondhand products trading market tends to increase or the contract rate after listing of the equipment 11-n on the secondhand products trading market is equal to or larger than a threshold.

When receiving the equipment information from the equipment information acquiring unit 51, the recommended listing price calculating unit 54 acquires the past transaction prices of the equipment 11-n in the secondhand products trading market from the storage device 15.

The recommended listing price calculating unit 54 calculates an average value of transaction prices of the equipment 11-n in the secondhand products trading market as a market price of the equipment 11-n in the secondhand products trading market (step ST4 in FIG. 8A and step ST33 in FIG. 9A).

For example, when the transaction prices for the past three days are acquired as the past transaction prices in the secondhand products trading market, the recommended listing price calculating unit 54 calculates an average value of the transaction prices for the past three days.

The recommended listing price calculating unit 54 outputs the average value of the transaction prices to the solicitation notice transmitting unit 53.

The solicitation notice transmitting unit 53 acquires the determination result from the demand determination unit 52 and acquires the average value of the transaction prices of the equipment 11-n from the recommended listing price calculating unit 54.

When the demand determination unit 52 determines that there is a demand (YES in step ST5 in FIG. 8A, and YES in step ST34 in FIG. 9A), the solicitation notice transmitting unit 53 transmits the listing solicitation notice for prompting listing of the equipment 11-n on the secondhand products trading market and the average value of the transaction prices to the solicitation notice receiving unit 24 of the first terminal device 14 via the network 20 (step ST6 in FIG. 8A and step ST35 in FIG. 9A).

When the demand determination unit 52 determines that there is no demand (NO in step ST5 in FIG. 8A, and NO in step ST34 in FIG. 9A), the solicitation notice transmitting unit 53 does not transmit the listing solicitation notice to the solicitation notice receiving unit 24 of the first terminal device 14.

In the equipment management server 19 illustrated in FIG. 5, the equipment information acquiring unit 51 of the equipment management server 19 acquires the equipment information included in the “purchases list” from the equipment information transmitting unit 22 of the first terminal device 14, and outputs the equipment information to each of the demand determination unit 52 and the recommended listing price calculating unit 54. When a flag indicating that the equipment 11-n is not intended to be sold is added to the equipment information included in the “purchases list”, the equipment information acquiring unit 51 may not output the equipment information indicating the equipment 11-n to each of the demand determination unit 52 and the recommended listing price calculating unit 54. In this case, the solicitation notice transmitting unit 53 does not transmit the listing solicitation notice to the solicitation notice receiving unit 24 of the first terminal device 14.

The solicitation notice receiving unit 24 of the first terminal device 14 receives the listing solicitation notice and the average value of the transaction prices from the solicitation notice transmitting unit 53 of the equipment management server 19 via the network 20 (step ST7 in FIG. 8A).

The solicitation notice receiving unit 24 outputs the listing solicitation notice and the average value of the transaction prices to the display processing unit 29.

The display processing unit 29 of the first terminal device 14 acquires the listing solicitation notice and the average value of the transaction prices from the solicitation notice receiving unit 24.

When acquiring the listing solicitation notice and the average value of the transaction prices, the display processing unit 29 generates display data of a listing solicitation image that prompts listing of the equipment 11-n on the secondhand products trading market. The listing solicitation image also includes information indicating the average value of transaction prices as the market price of the equipment 11-n.

The display processing unit 29 outputs the display data to the display output device 13 so as to display the listing solicitation image on the display of the display output device 13 as illustrated in FIG. 14 (step ST8 in FIG. 8A).

FIG. 14 is an explanatory diagram illustrating an example of the listing solicitation image.

FIG. 14 shows an example of the listing solicitation image that prompts listing of the air conditioner having equipment information of “ABC-0001” and the television having equipment information of “TV-567” in the secondhand products trading market because there is a demand for them in the secondhand products trading market.

Specifically, a message indicating “If you list the air conditioner ‘ABC-0001’ for sale on the secondhand products trading market, it can be potentially sold for xxx yen”. In addition, a message indicating “If you list the television ‘TV-567’ for sale on the secondhand products trading market, it can be potentially sold for xxx yen”. xxx yen is an average value of transaction prices in the secondhand products trading market.

When the listing solicitation image is displayed on the display of the display output device 13 and the first user views the listing solicitation image, the first user may be interested in listing the equipment 11-n for sale on the secondhand products trading market. When the first user is interested in listing, he/she may consider listing.

In the first terminal device 14 illustrated in FIG. 2, when acquiring the listing solicitation notice and the average value of the transaction prices, the display processing unit 29 generates display data of the listing solicitation image that prompts listing of the equipment 11-n on the secondhand products trading market. The display processing unit 29 may generate the display data of the listing solicitation image prompting listing of the equipment 11-n on the secondhand products trading market only when a flag indicating that the equipment 11-n is intended to be sold is added to the equipment information included in the “purchases list”.

The operation input device 12 receives, for example, an operation indicating an intention of “considering listing the equipment 11-n for sale on the secondhand products trading market” as the first user operation.

When receiving the operation indicating the intention of “considering listing the equipment 11-n for sale on the secondhand products trading market”, the operation input device 12 outputs a transmission request to transmit a listing consideration notice to the listing consideration notification unit 25 of the first terminal device 14.

Upon receiving the transmission request to transmit the listing consideration notice from the operation input device 12, the listing consideration notification unit 25 of the first terminal device 14 transmits the listing consideration notice including the equipment information indicating the equipment 11-n to each of the solicitation notice transmitting unit 53 and the recommended listing price calculating unit 54 in the equipment management server 19 via the network 20 (step ST9 in FIG. 8A).

When receiving the listing consideration notice from the listing consideration notification unit 25 of the first terminal device 14 via the network 20 (YES in step ST10 in FIG. 8A, and YES in step ST36 in FIG. 9A), the recommended listing price calculating unit 54 of the equipment management server 19 calculates a recommended listing price on the basis of the average value of the transaction prices calculated previously (step ST11 in FIG. 8A and step ST37 in FIG. 9A).

When not receiving the listing consideration notice (NO in step ST10 in FIG. 8A, and NO in step ST36 in FIG. 9A), the recommended listing price calculating unit 54 waits until receiving the listing consideration notice.

The processing of calculating the recommended listing price by the recommended listing price calculating unit 54 will be specifically described below.

When, for example, the usage condition of the equipment 11-n is stored in the storage device 15, the recommended listing price calculating unit 54 acquires the usage condition of the equipment 11-n from the storage device 15. Examples of the conceivable usage condition of the equipment 11-n include the total operating time and use frequency of the equipment 11-n, and the usage condition may be reported by the first user who owns the equipment 11-n and stored in the storage device 15.

When the equipment 11-n is an IoT device, the recommended listing price calculating unit 54 acquires the operation log from the equipment 11-n and confirms the usage condition of the equipment 11-n by referring to the operation log.

When the warranty status of the equipment 11-n is stored in the storage device 15, the recommended listing price calculating unit 54 acquires the warranty status from the storage device 15. Examples of conceivable warranty status include the ordinary manufacturer's one-year warranty, the manufacturer's extended warranty, and the extended warranty by a delivery agent.

When information indicating that the equipment 11-n is “unused”, information indicating that the equipment is “unopened”, or information indicating that “the equipment has a scratch” is stored in the storage device 15, the recommended listing price calculating unit 54 acquires these pieces of information from the storage device 15. These pieces of information may be stored in the storage device 15 when the first user who owns the equipment 11-n reports the usage condition.

When information indicating the purchase date of the equipment 11-n or information indicating the maintenance notes of the equipment 11-n is stored in the storage device 15, the recommended listing price calculating unit 54 acquires the information indicating the purchase date of the equipment 11-n or the information indicating the maintenance notes of the equipment 11-n from the storage device 15.

The recommended listing price calculating unit 54 acquires specification information of the equipment 11-n from the server of the manufacturer by, for example, transmitting the equipment information indicating the equipment 11-n to the server of the manufacturer of the equipment 11-n.

The recommended listing price calculating unit 54 sets an assessment coefficient k₁ of the equipment 11-n depending on the usage condition of the equipment 11-n.

That is, the recommended listing price calculating unit 54 classifies the usage condition of the equipment 11-n into, for example, three categories, that is, a high usage condition, a medium usage condition, and a low usage condition. When the usage condition of the equipment 11-n is, for example, lower than a first threshold, the equipment is classified as the low usage condition, and when the usage condition of the equipment 11-n is, for example, equal to or higher than the first threshold and equal to or lower than a second threshold higher than the first threshold, the equipment is classified as the medium usage condition. When the usage condition of the equipment 11-n is, for example, higher than the second threshold, the equipment is classified as the high usage condition.

When the usage condition of the equipment 11-n is the low usage condition, the recommended listing price calculating unit 54 sets the assessment coefficient k₁ to, for example, a coefficient larger than “1”, because the probability of failure is low.

When the usage condition of the equipment 11-n is the medium usage condition, the recommended listing price calculating unit 54 sets the assessment coefficient k₁ to a value smaller than the value of the assessment coefficient k₁ when the usage condition is the low usage condition, because the probability of failure is higher than that in the low usage condition.

When the usage condition of the equipment 11-n is the high usage condition, the recommended listing price calculating unit 54 sets the assessment coefficient k₁ to a value smaller than the value of the assessment coefficient k₁ when the usage condition is the medium usage condition, because the probability of failure is higher than that in the medium usage condition. The assessment coefficient k₁ is set to a coefficient smaller than “1”, for example.

The recommended listing price calculating unit 54 sets an assessment coefficient k₂ of the equipment 11-n depending on the warranty status of the equipment 11-n.

That is, when the warranty is purchased, the recommended listing price calculating unit 54 sets the assessment coefficient k₂ to, for example, a coefficient larger than “1”.

When the warranty is not purchased, the recommended listing price calculating unit 54 sets the assessment coefficient k₂ to, for example, a coefficient smaller than “1”.

When the information indicating that the equipment 11-n is “unused” is stored in the storage device 15, the recommended listing price calculating unit 54 sets a coefficient larger than “1”, for example, as an assessment coefficient k₃ of the equipment 11-n.

When the information indicating that the equipment 11-n is “unopened” is stored in the storage device 15, the recommended listing price calculating unit 54 sets the assessment coefficient k₃ of the equipment 11-n to a value larger than the value of the assessment coefficient k₃ when the equipment 11-n is “unused”.

When the information indicating that the equipment 11-n is “unused” or the information indicating that the equipment 11-n is “unopened” is not stored in the storage device 15, the recommended listing price calculating unit 54 sets “1” to the assessment coefficient k₃, for example.

The recommended listing price calculating unit 54 calculates a recommended listing price SP from the average value Pₐᵥₑ of the transaction prices of the equipment 11-n using the assessment coefficient k₁, the assessment coefficient k₂, and the assessment coefficient k₃ as represented by following Expression (1).

SP=Pₐᵥₑ×k₁×k₂×k₃ (1)

Expression (1) which is a computation expression of the recommended listing price SP is merely an example, and the computation expression of the recommended listing price SP by the recommended listing price calculating unit 54 is not limited to Expression (1).

The recommended listing price calculating unit 54 outputs the recommended listing price to each of the solicitation notice transmitting unit 53 and the listing notice transmitting unit 56.

In addition, when acquiring the information indicating that “the equipment 11-n has a scratch”, the information indicating the purchase date of the equipment 11-n, the information indicating the maintenance notes of the equipment 11-n, or the specification information of the equipment 11-n, the recommended listing price calculating unit 54 outputs the acquired information (hereinafter referred to as “equipment attribute information”) to the solicitation notice transmitting unit 53.

In a case where the first terminal device 14 illustrated in FIG. 2 has a function of, for example, unified management of home electric appliances, browsing of the instruction manual, or the like, or cooperates with an application having, as the main function, a function of unified management of home electric appliances, browsing of the instruction manual, or the like, the equipment attribute information can be easily acquired without the user newly performing the registration operation of registering the purchase date, the specification information, etc. of the equipment 11-n.

When receiving the listing consideration notice from the listing consideration notification unit 25 of the first terminal device 14 via the network 20, the solicitation notice transmitting unit 53 of the equipment management server 19 transmits the recommended listing price calculated by the recommended listing price calculating unit 54 to the solicitation notice receiving unit 24 of the first terminal device 14 via the network 20 (step ST12 in FIG. 8A and step ST38 in FIG. 9A).

Upon receiving the equipment attribute information from the recommended listing price calculating unit 54, the solicitation notice transmitting unit 53 transmits the equipment attribute information to the solicitation notice receiving unit 24 of the first terminal device 14 via the network 20.

The solicitation notice receiving unit 24 of the first terminal device 14 receives the recommended listing price from the solicitation notice transmitting unit 53 of the equipment management server 19 via the network 20 (step ST13 in FIG. 8A).

When the equipment attribute information is transmitted from the solicitation notice transmitting unit 53 of the equipment management server 19, the solicitation notice receiving unit 24 receives the equipment attribute information.

The solicitation notice receiving unit 24 outputs the recommended listing price to the display processing unit 29.

Upon receiving the equipment attribute information, the solicitation notice receiving unit 24 outputs the equipment attribute information to the display processing unit 29.

The display processing unit 29 of the first terminal device 14 acquires the recommended listing price from the solicitation notice receiving unit 24, and if the equipment attribute information is output from the solicitation notice receiving unit 24, acquires the equipment attribute information.

The display processing unit 29 generates display data of an image indicating the recommended listing price.

When acquiring the equipment attribute information, the display processing unit 29 generates display data of an image representing both the recommended listing price and the equipment attribute information.

The display processing unit 29 outputs the generated display data to the display output device 13 so as to display the image indicating the recommended listing price or the image indicating both the recommended listing price and the equipment attribute information on the display of the display output device 13 (step ST14 in FIG. 8A).

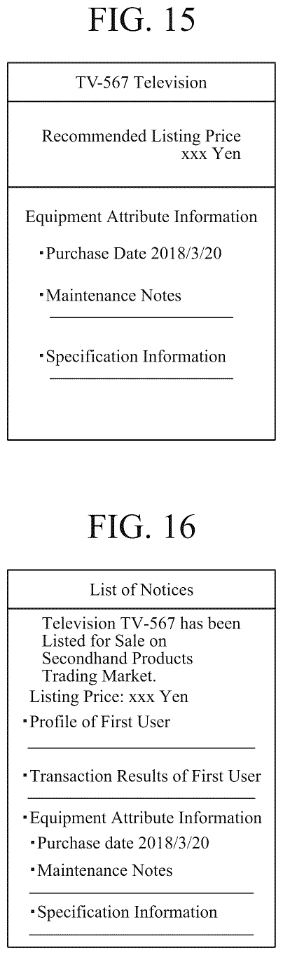

FIG. 15 is an explanatory diagram illustrating an example of an image indicating both the recommended listing price and the equipment attribute information.

In the example of FIG. 15, the equipment 11-n that is considered to be listed is a television having equipment information of “TV-567”, and thus, the recommended listing price of the television “TV-567” is displayed. In addition, the purchase date of the television, the maintenance notes, and the specification information are displayed as the equipment attribute information of the television “TV-567”.

When the image indicating the recommended listing price is displayed on the display of the display output device 13 and the first user views the image, the first user may determine that he/she lists the equipment 11-n for sale on the secondhand products trading market.

The operation input device 12 receives, for example, an operation indicating an intention of “listing the equipment 11-n for sale on the secondhand products trading market” as the first user operation.

When receiving the operation indicating the intention of “listing the equipment 11-n for sale on the secondhand products trading market”, the operation input device 12 outputs a transmission request to transmit a listing decision notice to the listing decision notification unit 26 of the first terminal device 14.

Here, it is assumed that the equipment 11-n is listed for sale on the secondhand products trading market when the operation input device 12 receives the operation indicating an intention of “listing the equipment 11-n for sale on the secondhand products trading market”.

In the first terminal device 14 illustrated in FIG. 2, the operation input device 12 receives the operation indicating an intention of “listing the equipment 11-n for sale on the secondhand products trading market” as the first user operation. In addition to the operation indicating the intention described above, the operation input device 12 may receive a change operation of changing the recommended listing price to a different price. In this case, the operation input device 12 outputs a transmission request to transmit the listing decision notice including the changed price to the listing decision notification unit 26 of the first terminal device 14. The listing price of the equipment 11-n in the secondhand products trading market is the changed recommended listing price.

When the operation input device 12 receives the operation indicating an intention of “listing the equipment 11-n for sale on the secondhand products trading market” as the first user operation, the listing decision notification unit 26 of the first terminal device 14 transmits a listing decision notice including the equipment information indicating the equipment 11-n to the first terminal searching unit 55 of the equipment management server 19 via the network 20 (step ST15 in FIG. 8A).

When receiving the listing decision notice from the listing decision notification unit 26 of the first terminal device 14 via the network 20 (YES in step ST16 in FIG. 8B, and YES in step ST39 in FIG. 9B), the first terminal searching unit 55 of the equipment management server 19 searches for the second terminal device 18 owned by the second user who is likely to purchase the equipment 11-n (step ST17 in FIG. 8B and step ST40 in FIG. 9B).

That is, the first terminal searching unit 55 transmits the listing decision notice to the storage device 15 via the network 20 and receives the search result of the second terminal device 18 from the storage device 15. When receiving the listing decision notice from the first terminal searching unit 55, the storage device 15 searches for the “favorites list” including the equipment information included in the listing decision notice from the “favorites lists” respectively corresponding to the plurality of users. The storage device 15 transmits information indicating the second terminal device 18 owned by the second user corresponding to the searched “favorites list” to the listing notice transmitting unit 56 as a search result of the second terminal device 18.

When not receiving the listing decision notice from the first terminal device 14 (NO in step ST16 in FIG. 8B, and NO in step ST39 in FIG. 9B), the first terminal searching unit 55 waits until receiving the listing decision notice.

The first terminal searching unit 55 outputs the search result of the second terminal device 18 to the listing notice transmitting unit 56. When the changed recommended listing price is included in the listing decision notice, the first terminal searching unit 55 outputs the changed recommended listing price to the listing notice transmitting unit 56.

The listing notice transmitting unit 56 of the equipment management server 19 acquires the search result of the second terminal device 18 from the first terminal searching unit 55, and specifies the second terminal device 18 owned by the second user who is likely to purchase the equipment 11-n on the basis of the search result.

For example, when one or more of the profile of the first user who owns the equipment 11-n, the transaction results of the first user in the secondhand products trading market, and the like is stored in the storage device 15, the listing notice transmitting unit 56 acquires any one or more of the profile of the first user, the transaction results, and the like from the storage device 15. When the first user who owns the equipment 11-n reports any one or more of the profile, the transaction results, and the like, the profile, the transaction results, and the like may be stored in the storage device 15.

When the changed recommended listing price is output from the first terminal searching unit 55, the listing notice transmitting unit 56 adds the changed recommended listing price to the listing notice indicating that the equipment 11-n has been listed for sale.

When the changed recommended listing price is not output from the first terminal searching unit 55, the listing notice transmitting unit 56 adds the recommended listing price output from the recommended listing price calculating unit 54 to the listing notice.

In addition, the listing notice transmitting unit 56 adds any one or more of the profile of the first user, the transaction results, and the like to the listing notice, and transmits the listing notice to the notice transmitting and receiving unit 27 of the specified second terminal device 18 via the network 20 (step ST18 in FIG. 8B and step ST41 in FIG. 9B).

The notice transmitting and receiving unit 27 of the second terminal device 18 receives the listing notice from the listing notice transmitting unit 56 of the equipment management server 19 via the network 20 (step ST19 in FIG. 8B).

The notice transmitting and receiving unit 27 outputs the listing notice to the display processing unit 29.

The display processing unit 29 of the second terminal device 18 acquires the listing notice from the notice transmitting and receiving unit 27.

When acquiring the listing notice, the display processing unit 29 generates display data of an image indicating the listing notice. The image indicating the listing notice includes the image indicating the profile of the first user or the transaction results.

The display processing unit 29 outputs the generated display data to the display output device 17 so as to display the image representing the listing notice on the display of the display output device 17 (step ST20 in FIG. 8B).

FIG. 16 is an explanatory diagram illustrating an example of the image indicating the listing notice.

In the example of FIG. 16, the equipment 11-n that is listed for sale is the television having equipment information of “TV-567”, and thus, the message indicating that the television “TV-567” has been listed for sale on the secondhand products trading market is displayed.

Further, the listing price of the television “TV-567”, the profile of the first user that has listed the television “TV-567” for sale, the transaction results of the first user, and the equipment attribute information are displayed. The equipment attribute information is the one illustrated in FIG. 15, and includes the purchase date, the maintenance notes, and the specification information.

When the image indicating the listing notice is displayed on the display of the display output device 17 and the second user views the image, the second user may determine that he/she purchases the equipment 11-n.

The operation input device 16 receives, for example, an operation indicating an intention of “purchasing the equipment 11-n” as the second user operation.

When receiving the operation indicating the intention of “purchasing the equipment 11-n”, the operation input device 16 outputs a transmission request to transmit an equipment purchase notice to the purchase decision notification unit 28 of the second terminal device 18.

Upon receiving the transmission request to transmit the equipment purchase notice from the operation input device 16, the purchase decision notification unit 28 of the second terminal device 18 transmits the equipment purchase notice including the equipment information indicating the equipment 11-n to the first notice transmitting and receiving unit 57 of the equipment management server 19 via the network 20 (step ST21 in FIG. 8B).

The first notice transmitting and receiving unit 57 of the equipment management server 19 receives the equipment purchase notice from the purchase decision notification unit 28 of the second terminal device 18 via the network 20.

The first notice transmitting and receiving unit 57 transfers the equipment purchase notice to the notice transmitting and receiving unit 27 of the first terminal device 14 via the network 20 (step ST22 in FIG. 8B and step ST42 in FIG. 9B).

The notice transmitting and receiving unit 27 of the first terminal device 14 receives the equipment purchase notice from the first notice transmitting and receiving unit 57 of the equipment management server 19 via the network 20 (step ST23 in FIG. 8B).

The notice transmitting and receiving unit 27 outputs the equipment purchase notice to the display processing unit 29.

The display processing unit 29 of the first terminal device 14 acquires the equipment purchase notice from the notice transmitting and receiving unit 27.

When acquiring the equipment purchase notice, the display processing unit 29 generates display data of an image indicating that there is a prospective purchaser.

The display processing unit 29 outputs the generated display data to the display output device 13 so as to display the image indicating that there is a prospective purchaser on the display of the display output device 13 (step ST24 in FIG. 8B).

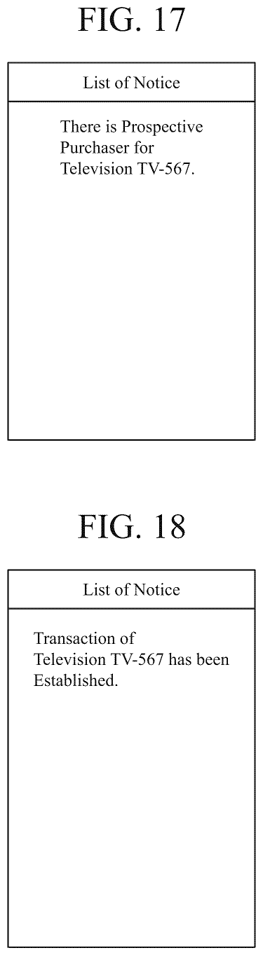

FIG. 17 is an explanatory diagram illustrating an example of the image indicating that there is a prospective purchaser.

In the example of FIG. 17, the equipment 11-n that has been listed for sale is the television having equipment information of “TV-567”, and thus, the message indicating that “there is a prospective purchaser for the television ‘TV-567’” is displayed.

When the image indicating that there is a prospective purchaser is displayed on the display of the display output device 13 and the first user views the image, the first user may determine that he/she sells the equipment 11-n. The number of prospective purchasers is not limited to one, and there may be a plurality of prospective purchasers.

The operation input device 12 receives, for example, an operation indicating an intention of “selling the equipment 11-n” as the first user operation.

When receiving the operation indicating the intention of “selling the equipment 11-n”, the operation input device 12 outputs a transmission request to transmit an equipment sale notice to the notice transmitting and receiving unit 27 of the first terminal device 14.

When the operation input device 12 receives the operation indicating an intention of “selling the equipment 11-n” as the first user operation, the notice transmitting and receiving unit 27 of the first terminal device 14 transmits an equipment sale decision notice to the first notice transmitting and receiving unit 57 of the; equipment management server 19 via the network 20 (step ST25 in FIG. 8B).

When receiving the equipment sale decision notice from the notice transmitting and receiving unit 27 of the first terminal device 14 via the network 20 (YES in step ST26 in FIG. 8B, and YES in step ST43 in FIG. 9B), the first notice transmitting and receiving unit 57 of the equipment management server 19 authorizes establishment of the transaction of the equipment 11-n.

When authorizing the establishment of the transaction for the equipment 11-n, the first notice transmitting and receiving unit 57 transmits a transaction establishment notice to the notice transmitting and receiving unit 27 of the second terminal device 18 via the network 20 (step ST27 in FIG. 8B and step ST44 in FIG. 9B).

When not receiving the equipment sale decision notice from the notice transmitting and receiving unit 27 of the first terminal device 14 (NO in step ST26 in FIG. 8B, and NO in step ST43 in FIG. 9B), the first notice transmitting and receiving unit 57 waits until receiving the equipment sale decision notice.

When receiving the transaction establishment notice from the first notice transmitting and receiving unit 57 of the equipment management server 19 via the network 20 (YES in step ST28 in FIG. 8B), the notice transmitting and receiving unit 27 of the second terminal device 18 outputs the transaction establishment notice to the display processing unit 29.

When not receiving the transaction establishment notice from the first notice transmitting and receiving unit 57 of the equipment management server 19 (NO in step ST28 in FIG. 8B), the notice transmitting and receiving unit 27 waits until receiving the transaction establishment notice.

The display processing unit 29 of the second terminal device 18 acquires the transaction establishment notice from the notice transmitting and receiving unit 27.

When acquiring the transaction establishment notice, the display processing unit 29 generates display data of an image indicating the establishment of the transaction.

The display processing unit 29 outputs the generated display data to the display output device 17 so as to display the image indicating the establishment of the transaction on the display of the display output device 17 (step ST29 in FIG. 8B).

FIG. 18 is an explanatory diagram illustrating an example of the image indicating the establishment of the transaction.

In the example of FIG. 18, the equipment 11-n that has been listed for sale is the television having equipment information of “TV-567”, and thus, the message indicating that “the transaction of the television ‘TV-567’ has been established” is displayed.

When the image indicating the establishment of the transaction is displayed on the display of the display output device 17 and the second user views the image, the second user can recognize that the transaction for the equipment 11-n has been established.

The establishment of the transaction here does not mean a complete establishment of transaction involving the establishment of the transfer of money, but means that the procedure for purchasing the television “TV-567” has been completed. It is to be noted, however, that the establishment of the transaction may mean a complete establishment of transaction involving the establishment of transfer of money.

The information processing system 1 illustrated in FIG. 1 cooperates with, for example, an Internet service including an application that handles customer to customer (C to C) transactions.

The information processing system 1 illustrated in FIG. 1 is not limited to a system that cooperates with an Internet service including an application, and may function as a part of an Internet service including an application that handles customer to customer (C to C) transactions.

Thereafter, the first user uses the first terminal device 14 and the second user uses the second terminal device 18 to start the C to C transaction handled by the application, whereby the trade of the equipment 11-n is carried out.

In the first embodiment described above, the equipment management server 19 includes: the equipment information acquiring unit 51 that acquires, from the first terminal device 14 in which the equipment 11-n owned by a user is registered, equipment information indicating the equipment 11-n; the demand determination unit 52 that acquires a transaction result of the equipment 11-n indicated by the equipment information acquired by the equipment information acquiring unit 51 in a secondhand products trading market, and determines whether or not there is a demand for the equipment 11-n in the secondhand products trading market on the basis of the transaction result; and the solicitation notice transmitting unit 53 that transmits, to the first terminal device 14, a listing solicitation notice prompting listing of the equipment 11-n on the secondhand products trading market when the demand determination unit 52 determines that there is a demand. With this configuration, the equipment management server 19 is capable of prompting listing of the equipment 11-n registered on a “purchases list” on the secondhand products trading market, regardless of whether or not the equipment 11-n registered on the “purchases list” matches equipment registered on the “favorites list”.

In the information processing system 1 illustrated in FIG. 1, when authorizing the establishment of the transaction for the equipment 11-n, the first notice transmitting and receiving unit 57 of the equipment management server 19 transmits the transaction establishment notice to the notice transmitting and receiving unit 27 of the second terminal device 18 via the network 20. However, this is merely an example, and the first notice transmitting and receiving unit 57 of the equipment management server 19 may transmit the transaction establishment notice to the notice transmitting and receiving unit 27 of the first terminal device 14 via the network 20, when authorizing the establishment of the transaction for the equipment 11-n.

When receiving the transaction establishment notice by the notice transmitting and receiving unit 27, the equipment registration unit 21 of the first terminal device 14 performs processing of canceling the registration of the equipment 11-n registered on the “purchases list” or processing of changing a status to a “transferred/sold” status that can be identified on the screen while the equipment 11-n remains registered. FIG. 2 does not illustrate an arrow from the notice transmitting and receiving unit 27 to the equipment registration unit 21.

On the other hand, when receiving the transaction establishment notice by the notice transmitting and receiving unit 27, the equipment registration unit 21 of the second terminal device 18 registers the equipment information indicating the equipment 11-n on the “purchases list”.

### Second Embodiment

A second embodiment will describe an equipment management server 19 that receives, from a certain terminal device, a purchase offer for equipment not listed for sale on the secondhand products trading market.

The purchase offer here means a purchase offer for equipment that is not currently listed for sale on the secondhand products trading market, but if the equipment is listed for sale on the secondhand products trading market, the purchase offer means having an intention to purchase the equipment.

The configuration of an information processing system 1 according to the second embodiment is similar to the configuration of the information processing system 1 according to the first embodiment, and FIG. 1 is applied as the configuration diagram illustrating the information processing system 1 according to the second embodiment.

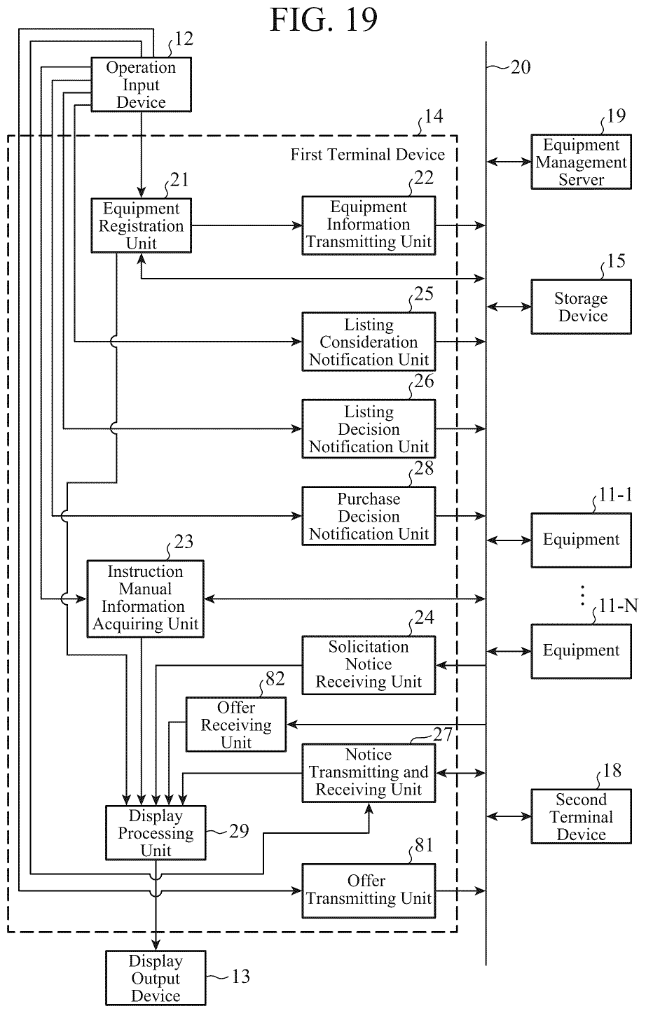

FIG. 19 is a configuration diagram illustrating a first terminal device 14 according to the second embodiment. In FIG. 19, elements same as or corresponding to the elements in FIG. 2 are identified by the same reference numerals, and thus, the description thereof will be omitted.

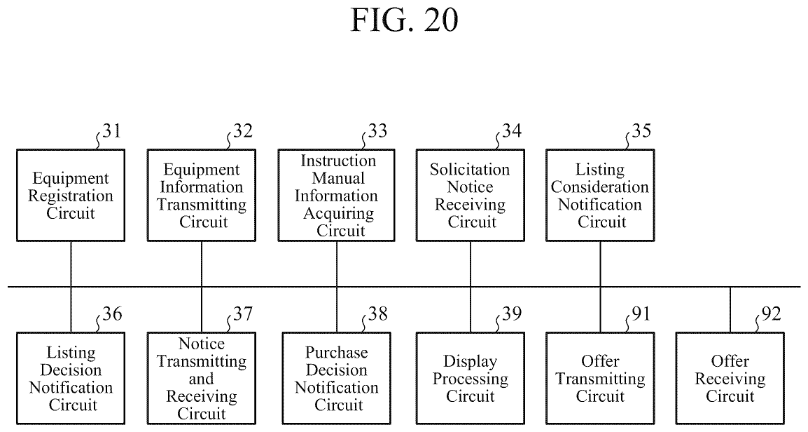

FIG. 20 is a hardware configuration diagram illustrating hardware of the first terminal device 14 according to the second embodiment. In FIG. 20, elements same as or corresponding to the elements in FIG. 3 are identified by the same reference numerals, and thus, the description thereof will be omitted.

The configuration of a second terminal device 18 is similar to the configuration of the first terminal device 14, and FIG. 19 is applied as a configuration diagram illustrating the second terminal device 18.

It is to be noted that, in the second terminal device 18, an operation input device connected to the second terminal device 18 is an operation input device 16, and a display output device connected to the second terminal device 18 is a display output device 17.

An offer transmitting unit 81 is implemented by, for example, an offer transmitting circuit 91 illustrated in FIG. 20.

When receiving, from the operation input device 16, a transmission request to transmit a purchase offer for equipment not listed for sale on the secondhand products trading market, the offer transmitting unit 81 of the second terminal device 18 transmits the purchase offer including equipment information of the equipment to the equipment management server 19 via the network 20.

An offer receiving unit 82 is implemented by, for example, an offer receiving circuit 92 illustrated in FIG. 20.

When receiving the purchase offer from the equipment management server 19 via the network 20, the offer receiving unit 82 of the first terminal device 14 outputs the purchase offer to the display processing unit 29.

In FIG. 19, it is assumed that each of the equipment registration unit 21, the equipment information transmitting unit 22, the instruction manual information acquiring unit 23, the solicitation notice receiving unit 24, the listing consideration notification unit 25, the listing decision notification unit 26, the notice transmitting and receiving unit 27, the purchase decision notification unit 28, the display processing unit 29, the offer transmitting unit 81, and the offer receiving unit 82, which are components of the first terminal device 14, is implemented by dedicated hardware as illustrated in FIG. 20. That is, it is assumed that the first terminal device 14 is implemented by the equipment registration circuit 31, the equipment information transmitting circuit 32, the instruction manual information acquiring circuit 33, the solicitation notice receiving circuit 34, the listing consideration notification circuit 35, the listing decision notification circuit 36, the notice transmitting and receiving circuit 37, the purchase decision notification circuit 38, the display processing circuit 39, the offer transmitting circuit 91, and the offer receiving circuit 92.

Each of the equipment registration circuit 31, the equipment information transmitting circuit 32, the instruction manual information acquiring circuit 33, the solicitation notice receiving circuit 34, the listing consideration notification circuit 35, the listing decision notification circuit 36, the notice transmitting and receiving circuit 37, the purchase decision notification circuit 38, the display processing circuit 39, the offer transmitting circuit 91, and the offer receiving circuit 92 is, for example, a single circuit, a composite circuit, a programmed processor, a parallel programmed processor, an ASIC, an FPGA, or a combination of some of these circuits.

The components of the first terminal device 14 are not limited to be implemented by dedicated hardware, and the first terminal device 14 may be implemented by software, firmware, or a combination of software and firmware.

In a case where the first terminal device 14 is implemented by software, firmware, or the like, an image display program for causing a computer to execute respective processing procedures performed by the equipment registration unit 21, the equipment information transmitting unit 22, the instruction manual information acquiring unit 23, the solicitation notice receiving unit 24, the listing consideration notification unit 25, the listing decision notification unit 26, the notice transmitting and receiving unit 27, the purchase decision notification unit 28, the display processing unit 29, the offer transmitting unit 81, and the offer receiving unit 82 is stored in the memory 41 illustrated in FIG. 4. Then, the processor 42 illustrated in FIG. 4 executes the image display program stored in the memory 41.

Further, FIG. 20 shows an example in which each of the components of the first terminal device 14 is implemented by dedicated hardware, and FIG. 4 shows an example in which the first terminal device 14 is implemented by software, firmware, or the like. However, this is merely an example, and some components in the first terminal device 14 may be implemented by dedicated hardware, and the remaining components may be implemented by software, firmware, or the like.

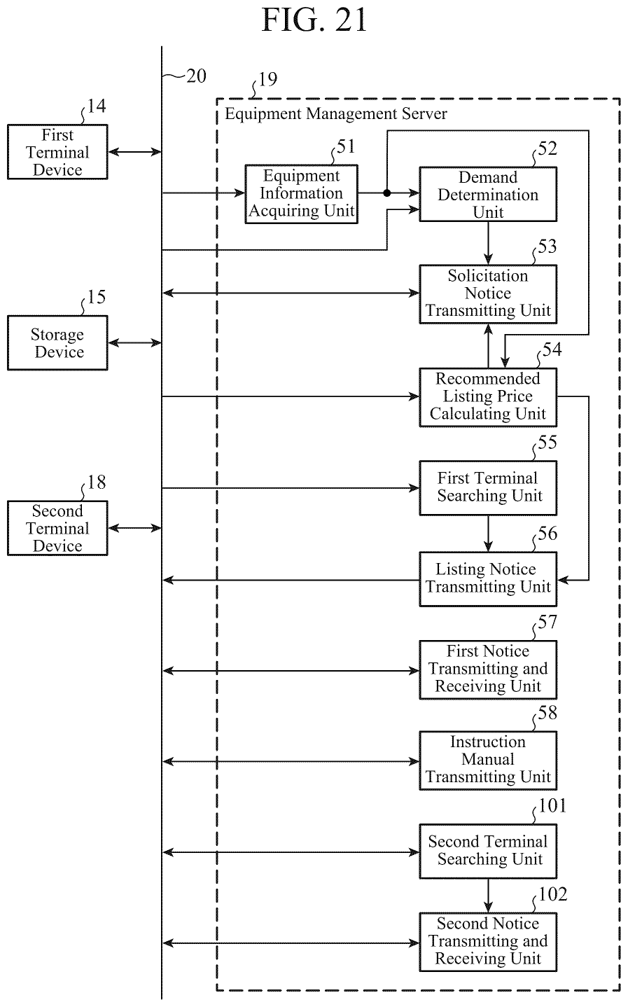

FIG. 21 is a configuration diagram illustrating the equipment management server 19 according to the second embodiment. In FIG. 21, elements same as or corresponding to the elements in FIG. 5 are identified by the same reference numerals, and thus, the description thereof will be omitted.

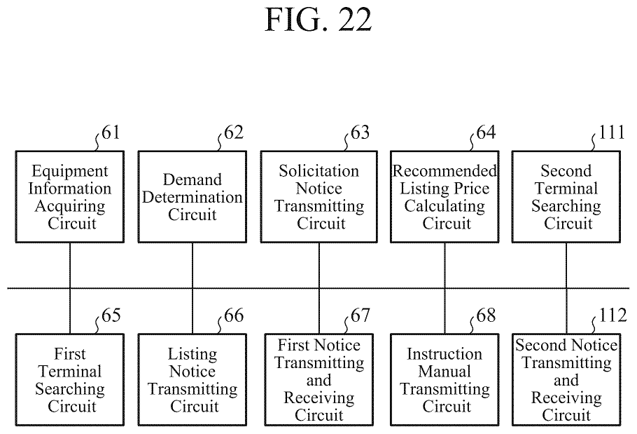

FIG. 22 is a hardware configuration diagram illustrating hardware of the equipment management server 19 according to the second embodiment. In FIG. 22, elements same as or corresponding to the elements in FIG. 6 are identified by the same reference numerals, and thus, the description thereof will be omitted.

A second terminal searching unit 101 is implemented by, for example, a second terminal searching circuit 111 illustrated in FIG. 22.

When receiving a purchase offer for equipment not listed for sale on the secondhand products trading market from a terminal device different from the first terminal device 14, the second terminal searching unit 101 searches for the first terminal device 14 that registers the equipment not listed for sale on the secondhand products trading market from among one or more first terminal devices 14.

The second terminal searching unit 101 outputs the search result of the first terminal device 14 to a second notice transmitting and receiving unit 102.

The second notice transmitting and receiving unit 102 is implemented by a second notice transmitting and receiving circuit 112 illustrated in FIG. 22.

The second notice transmitting and receiving unit 102 transmits a notice indicating that there is a purchase offer for the equipment to the first terminal device 14 searched by the second terminal searching unit 101 via the network 20.

When receiving an equipment sale decision notice indicating an intention to sell the equipment not listed on the secondhand products trading market from the first terminal device 14 via the network 20, the second notice transmitting and receiving unit 102 transmits, via the network 20, a transaction establishment notice indicating that the transaction of the equipment has been established to the terminal device that has transmitted the purchase offer.

In FIG. 21, it is assumed that each of the equipment information acquiring unit 51, the demand determination unit 52, the solicitation notice transmitting unit 53, the recommended listing price calculating unit 54, the first terminal searching unit 55, the listing notice transmitting unit 56, the first notice transmitting and receiving unit 57, the instruction manual transmitting unit 58, the second terminal searching unit 101, and the second notice transmitting and receiving unit 102 which are components of the equipment management server 19 is implemented by dedicated hardware as illustrated in FIG. 22. That is, it is assumed that the equipment management server 19 is implemented by the equipment information acquiring circuit 61, the demand determination circuit 62, the solicitation notice transmitting circuit 63, the recommended listing price calculating circuit 64, the first terminal searching circuit 65, the listing notice transmitting circuit 66, the first notice transmitting and receiving circuit 67, the instruction manual transmitting circuit 68, the second terminal searching circuit 111, and the second notice transmitting and receiving circuit 112.

Each of the equipment information acquiring circuit 61, the demand determination circuit 62, the solicitation notice transmitting circuit 63, the recommended listing price calculating circuit 64, the first terminal searching circuit 65, the listing notice transmitting circuit 66, the first notice transmitting and receiving circuit 67, the instruction manual transmitting circuit 68, the second terminal searching circuit 111, and the second notice transmitting and receiving circuit 112 is, for example, a single circuit, a composite circuit, a programmed processor, a parallel programmed processor, an ASIC, an FPGA, or a combination of some of these circuits.

The components of the equipment management server 19 are not limited to be implemented by dedicated hardware, and the equipment management server 19 may be implemented by software, firmware, or a combination of software and firmware.

In a case where the equipment management server 19 is implemented by software, firmware, or the like, an information processing program for causing a computer to execute respective processing procedures performed by the equipment information acquiring unit 51, the demand determination unit 52, the solicitation notice transmitting unit 53, the recommended listing price calculating unit 54, the first terminal searching unit 55, the listing notice transmitting unit 56, the first notice transmitting and receiving unit 57, the instruction manual transmitting unit 58, the second terminal searching unit 101, and the second notice transmitting and receiving unit 102 is stored in the memory 71 illustrated in FIG. 7. Then, the processor 72 illustrated in FIG. 7 executes the information processing program stored in the memory 71.

Further, FIG. 22 shows an example in which each of the components of the equipment management server 19 is implemented by dedicated hardware, and FIG. 7 shows an example in which the equipment management server 19 is implemented by software, firmware, or the like. However, this is merely an example, and some components in the equipment management server 19 may be implemented by dedicated hardware, and the remaining components may be implemented by software, firmware, or the like.

Next, the operation of the information processing system 1 according to the second embodiment will be described.

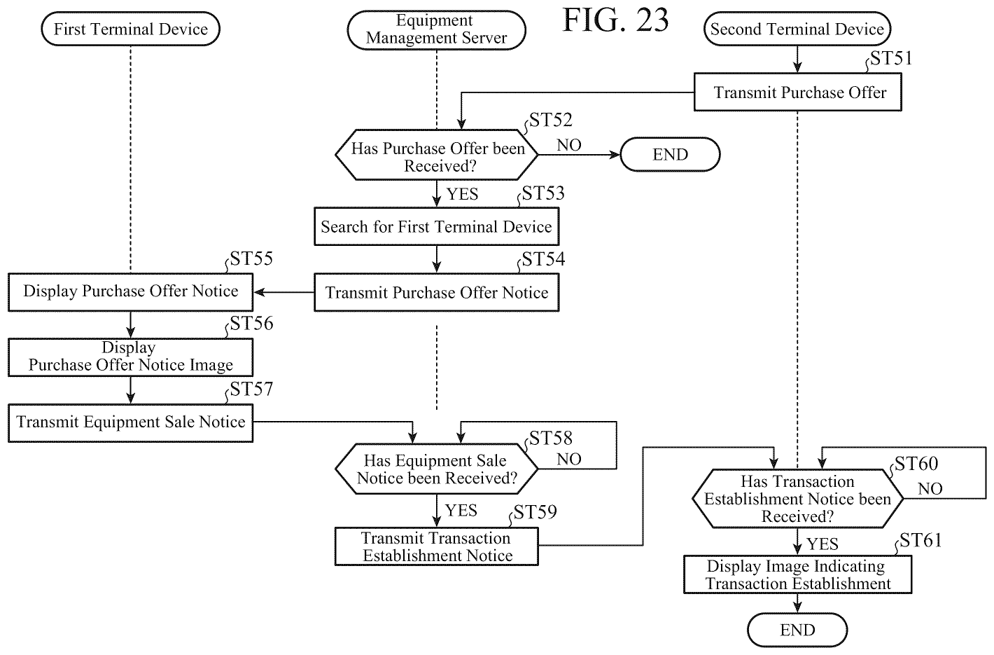

FIG. 23 is a time chart illustrating main parts of the procedures of processing performed by the first terminal device 14, the second terminal device 18, and the equipment management server 19, respectively.

In the information processing system 1 according to the second embodiment, it is assumed that a terminal device different from the first terminal device 14, that is, a terminal device that transmits a purchase offer, is the second terminal device 18. Here, differences from the information processing system 1 according to the first embodiment will be described.

For example, the second user checks whether or not equipment registered on the “favorites list” or equipment not registered on the “favorites list” but of interest is listed for sale on the secondhand products trading market.

For example, the second user can check whether or not equipment of interest or the like is listed for sale on the secondhand products trading market by using an Internet service including an application that handles customer to customer (C to C) transactions in cooperation with the information processing system 1 illustrated in FIG. 1 or an Internet service including an application that handles customer to customer (C to C) transactions and having the function of the information processing system 1 illustrated in FIG. 1.

When the equipment of interest or the like is not listed for sale on the secondhand products trading market, the second user can make a purchase offer to purchase the equipment of interest or the like by operating the operation input device 16.

The operation input device 16 receives, for example, an operation of requesting transmission of a purchase offer for equipment that is not listed for sale on the secondhand products trading market, that is, equipment of interest, as the second user operation.

The operation of requesting transmission of the purchase offer is an operation of receiving a transmission request to transmit the purchase offer for the equipment of interest or the like, and includes an operation of receiving an input of equipment information indicating the equipment of interest or the like.

In addition, the operation of requesting transmission of the purchase offer includes an operation of receiving an input of a desired purchase condition. The desired purchase condition includes a purchase price of the equipment of interest or the like, a usage condition of the equipment 11-n, and the like.

The operation input device 16 outputs a transmission request to transmit the purchase offer including the equipment information and the desired purchase conditions to the offer transmitting unit 81 of the second terminal device 18.

When receiving, from the operation input device 16, the transmission request to transmit the purchase offer, the offer transmitting unit 81 of the second terminal device 18 transmits the purchase offer including the equipment information and the desired purchase conditions to the second terminal searching unit 101 and the second notice transmitting and receiving unit 102 of the equipment management server 19 via the network 20 (step ST51 in FIG. 23).

The second terminal searching unit 101 of the equipment management server 19 receives the purchase offer from the offer transmitting unit 81 of the second terminal device 18 via the network 20.

When receiving the purchase offer (YES in step ST52 in FIG. 23), the second terminal searching unit 101 searches for the first terminal device 14 in which the equipment information included in the purchase offer is added to the “purchases list” from among one or more first terminal devices 14 (step ST53 in FIG. 23).

That is, the second terminal searching unit 101 transmits the purchase offer to the storage device 15 via the network 20 and receives the search result of the first terminal device 14 from the storage device 15. When receiving the purchase offer from the second terminal searching unit 101, the storage device 15 searches for the “purchases list” that includes the equipment information included in the purchase offer and that corresponds to the first user from the “purchases lists” respectively corresponding to the plurality of users. The storage device 15 transmits information indicating the first terminal device 14 owned by the first user corresponding to the searched “purchases list” to the second terminal searching unit 101 as a search result of the first terminal device 14.

The second terminal searching unit 101 outputs the search result of the first terminal device 14 to the second notice transmitting and receiving unit 102.

When not receiving the purchase offer (NO in step ST52 in FIG. 23), the second terminal searching unit 101 does not search for the first terminal device 14.

The second notice transmitting and receiving unit 102 of the equipment management server 19 receives the purchase offer from the offer transmitting unit 81 of the second terminal device 18 via the network 20.

The second notice transmitting and receiving unit 102 transmits a purchase offer notice indicating that the purchase offer for the equipment is presented to the first terminal device 14 searched by the second terminal searching unit 101 to the offer receiving unit 82 via the network 20 (step ST54 in FIG. 23). The purchase offer notice includes the equipment information and the desired purchase conditions.

The offer receiving unit 82 of the first terminal device 14 receives the purchase offer notice from the second notice transmitting and receiving unit 102 of the equipment management server 19 via the network 20 (step ST55 in FIG. 23).

The offer receiving unit 82 outputs the purchase offer notice to the display processing unit 29.

The display processing unit 29 of the first terminal device 14 acquires the purchase offer notice from the offer receiving unit 82.

The display processing unit 29 generates display data of a purchase offer image indicating both the equipment 11-n indicated by the equipment information and the desired purchase conditions which are included in the purchase offer notice.

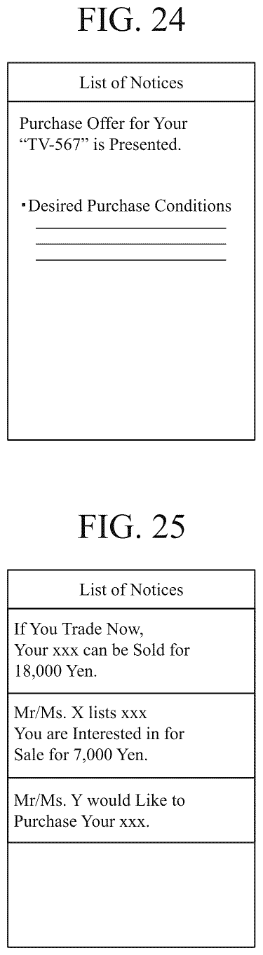

The display processing unit 29 outputs the generated display data to the display output device 13 so as to display the purchase offer image illustrated in FIG. 24 on the display of the display output device 13 (step ST56 in FIG. 23).

FIG. 24 is an explanatory diagram illustrating an example of the purchase offer image.

In the example of FIG. 24, a message indicating that a purchase offer for the television “TV-567” which is the equipment of interest is presented and desired purchase conditions of the television are displayed.

When the purchase offer image is displayed on the display of the display output device 13 and the first user views the purchase offer image, the first user may determine that he/she sells the equipment 11-n.

The operation input device 12 receives, for example, an operation indicating an intention of “selling the equipment 11-n to which the purchase offer is presented” as the first user operation.

When receiving the operation indicating the intention of “selling the equipment 11-n to which the purchase offer is presented”, the operation input device 12 outputs a transmission request to transmit an equipment sale notice to the notice transmitting and receiving unit 27 of the first terminal device 14.

In the first terminal device 14 illustrated in FIG. 19, the operation input device 12 receives the operation indicating an intention of “selling the equipment 11-n to which the purchase offer is presented” as the first user operation. In addition to the operation indicating the intention described above, the operation input device 12 may receive an operation indicating an intention to negotiate an increase of the purchase price included in the desired purchase conditions, or an operation indicating that the purchase price is lowered because the usage condition or the like of the equipment 11-n desired by the second user is not satisfied.

When receiving, from the operation input device 12, the transmission request to transmit the equipment sale notice, the notice transmitting and receiving unit 27 of the first terminal device 14 transmits, via the network 20, the equipment sale notice indicating that the equipment 11-n to which the purchase offer has been presented is sold to the second notice transmitting and receiving unit 102 of the equipment management server 19 (step ST57 in FIG. 23).

When receiving the equipment sale notice from the notice transmitting and receiving unit 27 of the first terminal device 14 via the network 20 (YES in step ST58 in FIG. 23), the second notice transmitting and receiving unit 102 of the equipment management server 19 transmits a transaction establishment notice indicating that the transaction of the equipment 11-n having the purchase offer is established to the second terminal device 18, which is a terminal device that has transmitted the purchase offer, via the network 20 (step ST59 in FIG. 23). The establishment of the transaction also means that the procedure for purchasing the television “TV-567” has been established. It is to be noted, however, that the establishment of the transaction may mean a complete establishment of transaction involving the establishment of transfer of money.

When not receiving the equipment sale notice from the notice transmitting and receiving unit 27 of the first terminal device 14 (NO in step ST58 in FIG. 23), the second notice transmitting and receiving unit 102 waits until receiving the equipment sale notice from the notice transmitting and receiving unit 27.

When receiving the transaction establishment notice from the second notice transmitting and receiving unit 102 of the equipment management server 19 via the network 20 (YES in step ST60 in FIG. 23), the notice transmitting and receiving unit 27 of the second terminal device 18 outputs the transaction establishment notice to the display processing unit 29.

When not receiving the transaction establishment notice from the second notice transmitting and receiving unit 102 (NO in step ST60 in FIG. 23), the notice transmitting and receiving unit 27 waits until receiving the transaction establishment notice from the second notice transmitting and receiving unit 102.

When receiving the transaction establishment notice from the second notice transmitting and receiving unit 102, the display processing unit 29 of the second terminal device 18 generates display data of an image indicating the establishment of the transaction.

The display processing unit 29 outputs the generated display data to the display output device 17 so as to display the image indicating the establishment of the transaction on the display of the display output device 17 (step ST61 in FIG. 23).

In the information processing system 1 according to the second embodiment, when receiving the equipment sale notice from the notice transmitting and receiving unit 27 of the first terminal device 14, the second notice transmitting and receiving unit 102 transmits the transaction establishment notice to the second terminal device 18 which has transmitted the purchase offer. However, this is merely an example, and the second notice transmitting and receiving unit 102 may transmit, in place of the transaction establishment notice, the transaction condition of the equipment 11-n to the second terminal device 18 which has transmitted the purchase offer. Examples of conceivable transaction conditions include the desired purchase price presented by the first user who owns the equipment 11-n and approval of the individual state of the equipment 11-n. The individual state of the equipment 11-n is, for example, a status of deterioration of the equipment 11-n in addition to the usage condition of the equipment 11-n.

The notice transmitting and receiving unit 27 of the second terminal device 18 receives the transaction conditions of the equipment 11-n and outputs the transaction conditions of the equipment 11-n to the display processing unit 29.

The display processing unit 29 of the second terminal device 18 generates display data of an image indicating the transaction conditions of the equipment 11-n.

The display processing unit 29 outputs the generated display data to the display output device 17 so as to display the image indicating the transaction conditions on the display of the display output device 17.

When the second user who presents the purchase offer approves the transaction conditions, the operation input device 16 receives an approval operation of approving the transaction conditions as the second user operation, and outputs a transmission request to transmit a transaction-condition approval notice to the offer transmitting unit 81.

When receiving the transmission request to transmit the approval notice from the operation input device 16, the offer transmitting unit 81 of the second terminal device 18 transmits the approval notice to the second notice transmitting and receiving unit 102 of the equipment management server 19 via the network 20.

When receiving the approval notice from the second terminal device 18, the second notice transmitting and receiving unit 102 of the equipment management server 19 transmits a transaction establishment notice indicating that the transaction of the equipment 11-n has been established to the second terminal device 18 that has transmitted the purchase offer and the first terminal device 14 via the network 20.

The information processing system 1 according to the second embodiment cooperates with, for example, an application that handles customer to customer (C to C) transactions.

The information processing system 1 according to the second embodiment is not limited to a system that cooperates with an Internet service including an application, and may function as a part of an Internet service including an application that handles customer to customer (C to C) transactions.

Thereafter, the first user uses the first terminal device 14 and the second user uses the second terminal device 18 to start the C to C transaction handled by the application, whereby the trade of the equipment 11-n is carried out.

The second embodiment has described the equipment management server 19 that receives, from a certain terminal device, a purchase offer for equipment not listed for sale on the secondhand products trading market. With this configuration, the equipment management server 19 according to the second embodiment enables transaction of the equipment 11-n registered on a “purchases list”, regardless of whether or not the equipment 11-n registered on the “purchases list” matches equipment registered on the “favorites list”.

With the equipment management server 19 according to the second embodiment, the equipment 11-n which is registered on the “purchases list” but not listed for sale on the secondhand products trading market can also be sold. As a result, even in a case where the equipment 11-n registered on the “purchases list” is a dead storage product that the first user has not been intending to sell or a dead storage product that has not been expected by the first user to be sold, it is possible to sell the equipment 11-n.

In addition, although the conventional customer to customer (C to C) transaction is a seller-led transaction, the equipment management server 19 according to the second embodiment can achieve a buyer-led transaction by a purchase offer function.

That is, participants in a conventional customer to customer (C to C) transaction include only sellers having an intention of selling their equipment and buyers who choose and buy equipment from among equipment listed for sale on the secondhand products trading market. On the other hand, the customer to customer (C to C) transaction using the equipment management server 19 according to the second embodiment has a potential to stimulate the secondhand products trading market and increase the total transaction amount by soliciting new sellers originally having no intention of selling their equipment or new buyers presenting a purchase offer for equipment that is not listed for sale on the secondhand products trading market to the secondhand products trading market. In addition, it also has a potential to contribute to the formation of a cyclical society in which secondhand products are effectively utilized.

When the equipment of interest, etc. is not listed for sale on the secondhand products trading market, the operation input device 16 of the information processing system 1 according to the second embodiment receives an operation of requesting transmission of a purchase offer for the equipment of interest, etc. as the second user operation. However, this is merely an example, and when the equipment of interest or the like is listed for sale on the secondhand products trading market, the operation input device 16 may receive an operation indicating an intention of “purchasing the equipment of interest, etc.” as the second user operation.

When receiving the operation indicating the intention of “purchasing the equipment of interest, etc.”, the operation input device 16 outputs a transmission request to transmit an equipment purchase notice to the purchase decision notification unit 28 of the second terminal device 18.

Upon receiving the transmission request to transmit the equipment purchase notice from the operation input device 16, the purchase decision notification unit 28 of the second terminal device 18 transmits the equipment purchase notice including the equipment information indicating the equipment of interest, etc. to the first notice transmitting and receiving unit 57 of the equipment management server 19 via the network 20.

Thereafter, the transaction of the equipment of interest, etc. is conducted as in the same manner in the information processing system 1 according to the first embodiment.

In the information processing system 1 illustrated in FIG. 1, the solicitation notice transmitting unit 53 transmits the average value of transaction prices of the equipment 11-n indicated by the equipment information included in the “purchases list” to the solicitation notice receiving unit 24 of the first terminal device 14 via the network 20. However, this is merely an example, and the solicitation notice transmitting unit 53 may transmit the average value of transaction prices of the equipment 11-n indicated by the equipment information and equipment similar to the equipment 11-n to the solicitation notice receiving unit 24 of the first terminal device 14 via the network 20. Examples of conceivable equipment similar to the equipment 11-n include a high-end model in the same series as the equipment 11-n, a low-end model in the same series as the equipment 11-n, a previous year's model with the same grade as the equipment 11-n, a next year's model with the same grade as the equipment 11-n, and equipment having basic performance substantially the same as the basic performance of the equipment 11-n. The substantially same basic performance includes not only the same basic performance but also a similar basic performance with a difference within a threshold.

In addition, instead of transmitting the average value of the transaction prices of the equipment 11-n to the solicitation notice receiving unit 24 of the first terminal device 14 via the network 20, the solicitation notice transmitting unit 53 may transmit a price obtained by multiplying the average value of the transaction prices of the equipment 11-n by an arbitrary coefficient to the solicitation notice receiving unit 24 of the first terminal device 14 via the network 20.

In the information processing system 1 illustrated in FIG. 1, the display processing unit 29 displays an image as illustrated in FIG. 14, 16, or 17 on the display of the display output device 13. However, this is merely an example, and the display processing unit 29 may display, on the display of the display output device 13, a notice list image indicating all of the listing solicitation image, the image indicating the listing notice, and the image indicating that there is a prospective purchaser as illustrated in FIG. 25, for example. FIG. 25 is an explanatory diagram illustrating an example of the notice list image.

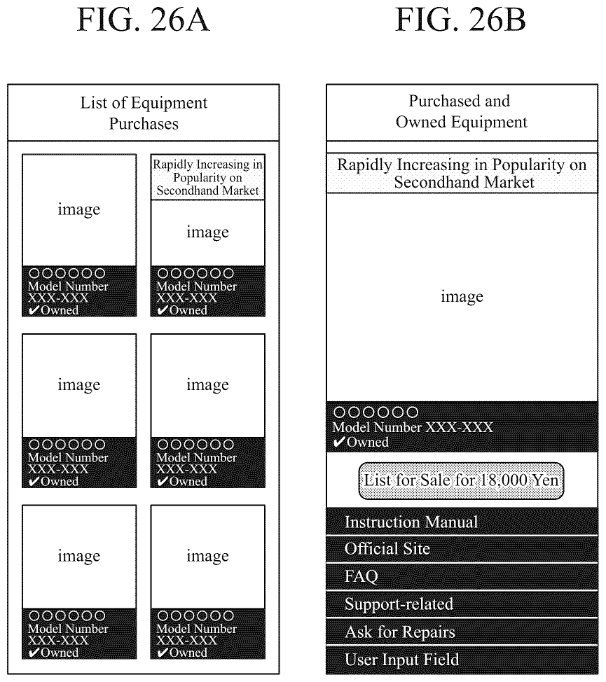

In the information processing system 1 illustrated in FIG. 1, the display processing unit 29 controls the display output device 13 so that the display output device 13 displays, as a list of equipment indicated by the equipment information included in the “purchases list”, the list of equipment illustrated in FIG. 12. However, this is merely an example, and the display processing unit 29 may control the display output device 13 so that the display output device 13 displays a list of equipment illustrated in FIG. 26A. Alternatively, the display processing unit 29 may select equipment in demand in the secondhand products trading market from among equipment 11-1 to 11-N included in the “purchases list” and display information of the selected equipment on the display of the display output device 13 as illustrated in FIG. 26B.

FIG. 26A is an explanatory diagram illustrating an example of a list of equipment, and FIG. 26B is an explanatory diagram illustrating information regarding equipment that has been purchased and is owned now.

In FIGS. 26A and 26B, equipment that is in demand in the secondhand products trading market among equipment that has been purchased and is owned now is attached with a message of “rapidly increasing in popularity in the secondhand market”.

In FIG. 26B, “18,000 yen” is displayed as the average value of the transaction prices in the secondhand products trading market. Instead of the average value of the transaction prices, the recommended listing price of the equipment may be displayed.

In FIGS. 26A and 26B, an image diagram illustrating the equipment is displayed in a region denoted by “image”. The image diagram indicating the equipment may be an illustration of the equipment or a real picture of the equipment.

In FIGS. 26A and 26B, the model number is equipment information.

In the information processing system 1 illustrated in FIG. 1, the display processing unit 29 controls the display output device 17 so that the display output device 17 displays a list of equipment indicated by the equipment information included in the “favorites list”, as in the list of equipment indicated by the equipment information included in the “purchases list”.

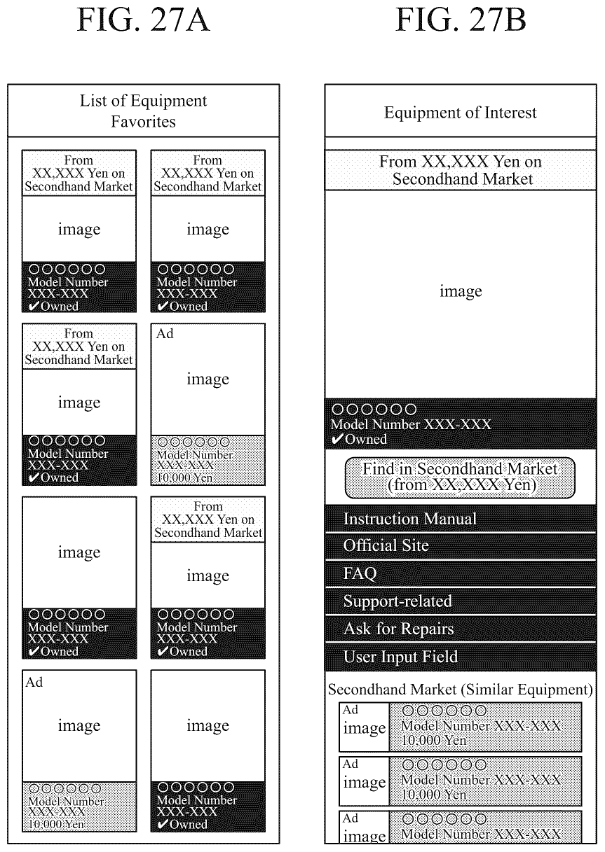

Therefore, the display processing unit 29 controls the display output device 17 so that the display output device 17 displays a list of equipment indicated by the equipment information included in the “favorites list” as illustrated in FIG. 27A. In addition, the display processing unit 29 controls the display output device 17 so that the display output device 17 displays information of any one of equipment 11-1 to 11-N included in the “favorites list” as illustrated in FIG. 27B, for example.

FIG. 27A is an explanatory diagram illustrating an example of a list of equipment, and FIG. 27B is an explanatory diagram illustrating information of any one of equipment 11-1 to 11-N included in the “favorites list”.

In FIGS. 27A and 27B, the equipment listed for sale on the secondhand products trading market is attached with a message of “from XX, XXX yen in the secondhand products trading market” as the transaction price on the secondhand products trading market. However, this is merely an example, and the equipment listed for sale on the secondhand products trading market may be attached with a message of “xx yen lower than brand-new equipment” or “xx % lower than brand-new equipment”, or the meaning of the message may be expressed by a graph.

In FIGS. 27A and 27B, an image diagram illustrating the equipment is displayed in a region denoted by “image”. The image diagram indicating the equipment may be an illustration of the equipment or a real picture of the equipment.

In FIGS. 27A and 27B, the model number is equipment information.

In FIGS. 27A and 27B, an advertisement of a product of interest or an advertisement of equipment different from the product of interest is displayed in a frame in which “Ad” is written. The equipment different from the product of interest may be a brand-new product or a secondhand product. The equipment different from the product of interest may also be equipment similar to the product of interest or equipment not similar to the product of interest.

FIG. 27B illustrates a button “Find in secondhand products trading market (from XX, XXX yen)” as a button for looking for the product of interest in the secondhand products trading market. In a case where the product of interest is not listed for sale on the secondhand products trading market, a button of “presenting a purchase offer” may be displayed as a button for presenting an offer to purchase the product of interest, instead of the button of “Find in secondhand products trading market (from XX,XXX yen)”.

In FIG. 27B, equipment similar to the product of interest is listed in a box of secondhand market (similar equipment). The box of secondhand market (similar equipment) may be used as an advertisement.

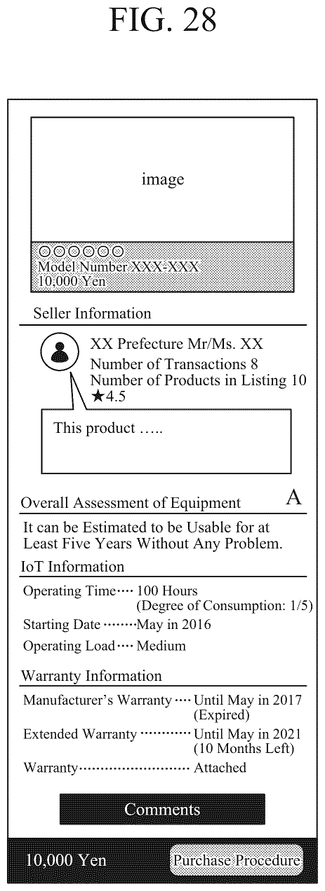

In the information processing system 1 illustrated in FIG. 1, the display processing unit 29 displays an image indicating a listing notice as illustrated in FIG. 16 on the display of the display output device 13. However, this is merely an example, and the display processing unit 29 may control the display output device 13 so that the display output device 13 displays an image illustrated in FIG. 28.

FIG. 28 is an explanatory diagram illustrating an example of the image indicating the listing notice.

In the example of FIG. 28, the listing price of the equipment 11-n and the image diagram illustrating the equipment 11-n are displayed. In addition, a profile of the first user and transaction results of the first user are displayed as seller information.

In addition, the overall assessment of the equipment 11-n, the information indicating the usage condition obtained from the operation log of the IoT device, and the warranty information of the equipment 11-n are displayed.

The overall assessment of the equipment 11-n is determined from the usage condition of the equipment 11-n, the warranty information of the equipment 11-n, and the like. For example, the overall assessment is higher as the age of use of the equipment 11-n is shorter or as the warranty is more generous.

In the information processing system 1 illustrated in FIG. 1, an object to be traded is “equipment”. Any object may be used as the object to be traded, as long as it is traded in auction, flea market, or the like, and the object to be traded may be tangible objects other than equipment, software, financial products, or products such as various rights.

When the object to be traded is a “product”, the equipment 11-n (n=1, . . . , N) illustrated in FIG. 1 is replaced with a product, and the equipment management server 19 illustrated in FIG. 1 is replaced with a product management server 19′.

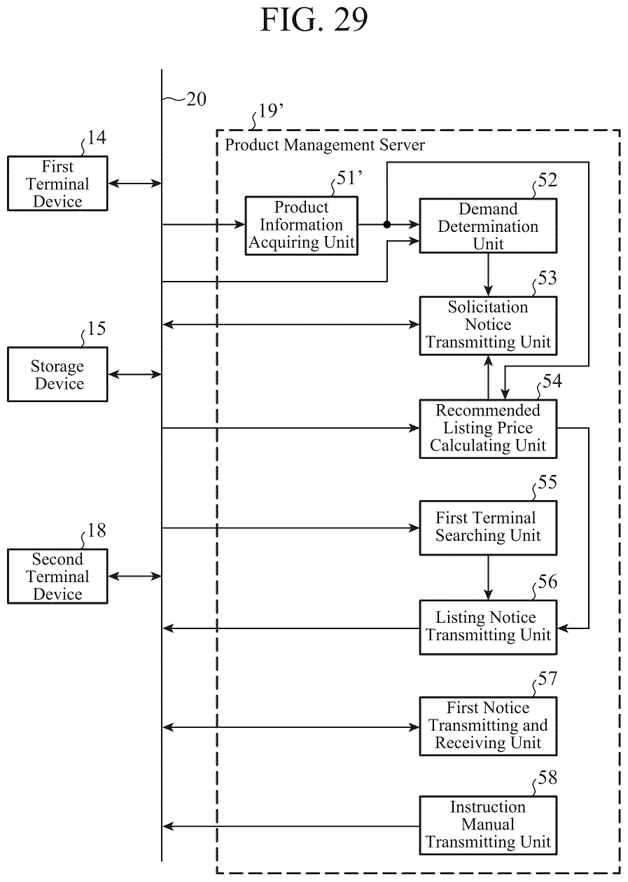

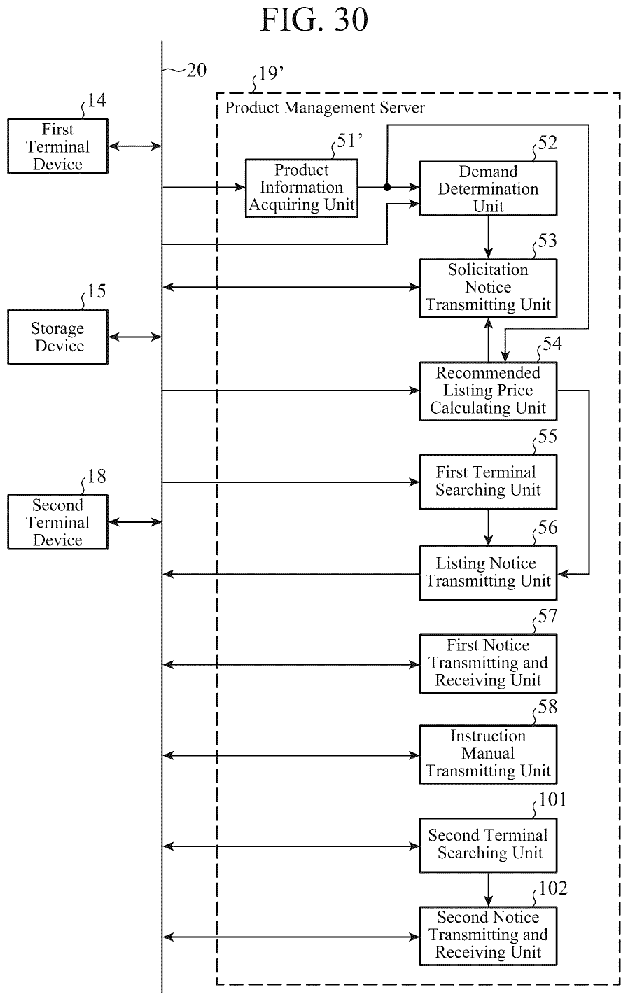

FIGS. 29 and 30 are configuration diagrams illustrating the product management server 19′. The product management server 19′ illustrated in FIG. 29 has a function similar to that of the equipment management server 19 illustrated in FIG. 5 except that the object to be traded is a “product”. In addition, the product management server 19′ illustrated in FIG. 30 has a function similar to that of the equipment management server 19 illustrated in FIG. 21 except that the object to be traded is a “product”. The “equipment” in the description regarding the equipment management server 19 is replaced with a “product”, and the equipment information acquiring unit 51 is replaced with a product information acquiring unit 51′.

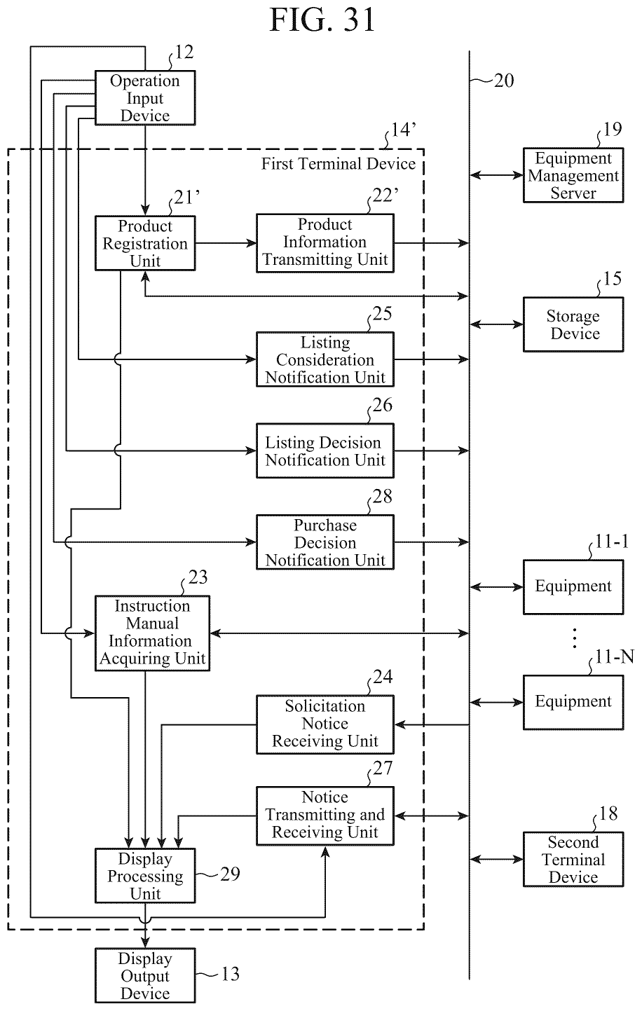

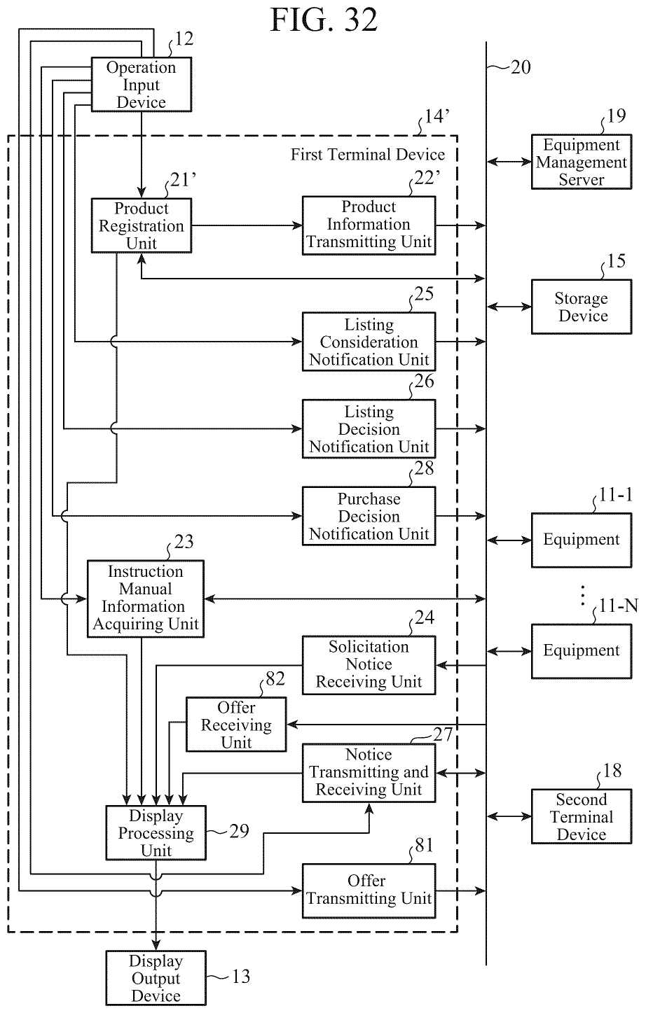

Further, FIGS. 31 and 32 are configuration diagrams illustrating a first terminal device 14′. The configuration of a second terminal device is similar to the configuration of the first terminal device 14′, and FIG. 31 or 32 is applied as a configuration diagram illustrating the second terminal device.

The first terminal device 14′ illustrated in FIG. 31 has a function similar to that of the first terminal device 14 illustrated in FIG. 2 except that the object to be traded is a “product”. The first terminal device 14′ illustrated in FIG. 32 has a function similar to that of the first terminal device 14 illustrated in FIG. 19 except that the object to be traded is a “product”. The “equipment” in the description regarding the first terminal device 14 is replaced with a “product”, the equipment registration unit 21 is replaced with a product registration unit 21′, and the equipment information transmitting unit 22 is replaced with a product information transmitting unit 22′.

It is to be noted that, in the present disclosure, two or more of the above embodiments can be freely combined, or any component in the embodiments can be modified or omitted.

### INDUSTRIAL APPLICABILITY

The present disclosure is suitable to an equipment management server, a terminal device, an information processing system, an information processing method, an information processing program, an image display method, an image display program, and a product management server.

### REFERENCE SIGNS LIST

1: information processing system, 11-1 to 11-N: equipment, 12: operation input device, 13: display output device, 14, 14′: first terminal device, 15: storage device, 16: operation input device, 17: display output device, 18: second terminal device, 19: equipment management server, 19′: product management server, 20: network, 21: equipment registration unit, 21′: product registration unit, 22: equipment information transmitting unit, 22′: product information transmitting unit, 23: instruction manual information acquiring unit, 24: solicitation notice receiving unit, 25: listing consideration notification unit, 26: listing decision notification unit, 27: notice transmitting and receiving unit, 28: purchase decision notification unit, 29: display processing unit, 31: equipment registration circuit, 32: equipment information transmitting circuit, 33: instruction manual information acquiring circuit, 34: solicitation notice receiving circuit, 35: listing consideration notification circuit, 36: listing decision notification circuit, 37: notice transmitting and receiving circuit, 38: purchase decision notification circuit, 39: display processing circuit, 41: memory, 42: processor, 51: equipment information acquiring unit, 51′: product information acquiring unit 52: demand determination unit, 53: solicitation notice transmitting unit, 54: recommended listing price calculating unit, 55: first terminal searching unit, 56: listing notice transmitting unit, 57: first notice transmitting and receiving unit, 58: instruction manual transmitting unit, 61: equipment information acquiring circuit, 62: demand determination circuit, 63: solicitation notice transmitting circuit, 64: recommended listing price calculating circuit, 65: first terminal searching circuit, 66: listing notice transmitting circuit, 67: first notice transmitting and receiving circuit, 68: instruction manual transmitting circuit, 71: memory, 72: processor, 81: offer transmitting unit, 82: offer receiving unit, 91: offer transmitting circuit, 92: offer receiving circuit, 101: second terminal searching unit, 102: second notice transmitting and receiving unit, 111: second terminal searching circuit, 112: second notice transmitting and receiving circuit

1. An equipment management server comprising:
processing circuitry to perform a process to:
acquire, from a first terminal device in which equipment owned by a user is registered, equipment information indicating the equipment;
acquire a transaction result of the equipment indicated by the equipment information acquired in a secondhand products trading market, and determine whether or not there is a demand for the equipment in the secondhand products trading market on a basis of the transaction result; and
transmit, to the first terminal device, a listing solicitation notice prompting listing of the equipment on the secondhand products trading market when the process determines that there is a demand.

2. The equipment management server according to claim 1, wherein the process acquires a number of transactions as the transaction result, in the secondhand products trading market, of the equipment indicated by the equipment information acquired, and determines that there is a demand for the equipment in the secondhand products trading market when the number of transactions tends to increase or the number of transactions is equal to or larger than a threshold.

3. The equipment management server according to claim 1, wherein the process transmits a representative value of a transaction price of the equipment in the secondhand products trading market to the first terminal device, the process further comprising: to calculate a recommended listing price which is a listing price recommended for the equipment in the secondhand products trading market on a basis of a representative value of a transaction price of the equipment in the secondhand products trading market when receiving, from the first terminal device, a notice indicating that listing of the equipment indicated by the equipment information on the secondhand products trading market is considered, wherein
the process transmits the recommended listing price calculated to the first terminal device, the process further comprising:
to search for a second terminal device owned by a user who is likely to purchase the equipment indicated by the equipment information when receiving a notice indicating that the equipment is listed on the secondhand products trading market from the first terminal device; and
to transmit a notice indicating that the equipment has been listed on the secondhand products trading market to the second terminal device searched, the process further comprising:
to search for the first terminal device that registers equipment not listed on the secondhand products trading market when receiving a purchase offer for the equipment not listed on the secondhand products trading market from a terminal device different from the first terminal device; and
to transmit a notice indicating that the purchase offer for the equipment is presented to the first terminal device searched, and when receiving, from the first terminal device, a notice indicating an intention of selling the equipment not listed on the secondhand products trading market, transmit a notice indicating that a transaction of the equipment not listed on the secondhand products trading market has been established or a transaction condition of the equipment to the terminal device that has transmitted the purchase offer.

4. The equipment management server according to claim 3, wherein when calculating the recommended listing price on a basis of the representative value of the transaction price of the equipment, the process calculates the recommended listing price using one or more of a usage condition of the equipment indicated by the equipment information and a warranty status of the equipment indicated by the equipment information.

5. The equipment management server according to claim 4, wherein when the equipment indicated by the equipment information is an IoT device, the process acquires an operation log of the equipment, checks the usage condition of the equipment from the operation log, and calculates the recommended listing price using one or more of the usage condition of the equipment and the warranty status of the equipment indicated by the equipment information.

6. The equipment management server according to claim 3, wherein the process transmits one or more of a profile of a user who has listed the equipment indicated by the equipment information on the secondhand products trading market and a transaction result of the user to the second terminal device searched.

7. The equipment management server according to claim 3, the process further comprising: to transmit a notice indicating that there is a prospective purchaser to the first terminal device when receiving a notice indicating an intention of purchasing the equipment indicated by the equipment information from the second terminal device, and to transmit a notice indicating that a transaction of the equipment has been established to the second terminal device when receiving a notice indicating an intention of selling the equipment from the first terminal device.

8. A terminal device comprising:
processing circuitry to perform a process to:
register equipment owned by a user;
transmit equipment information indicating the equipment registered to an equipment management server;
receive a listing solicitation notice for prompting listing of the equipment on the secondhand products trading market from the equipment management server when the equipment management server determines that there is a demand for the equipment indicated by the equipment information in the secondhand products trading market; and
generate and output display data of a listing solicitation image indicating that listing of the equipment on the secondhand products trading market is prompted when the listing solicitation notice is received.

9. The terminal device according to claim 8, the process further comprising: receive a notice indicating that a transaction of the equipment has been established from the equipment management server after the equipment has been listed on the secondhand products trading market, wherein
the process cancels registration of the equipment when the process receives the notice indicating that the transaction of the equipment has been established.

10. The terminal device according to claim 8, the terminal device being used by a user who does not own the equipment, the terminal device comprising:
processing circuitry to perform a process to:
receive a notice indicating that a transaction of the equipment has been established from the equipment management server after the equipment has been listed on the secondhand products trading market, wherein
the process registers the equipment when the process receives the notice indicating that a transaction of the equipment has been established.

11. An information processing system comprising:
a first terminal device in which equipment owned by a user is registered;
an equipment information acquirer to acquire, from the first terminal device, equipment information indicating the equipment;
a demand determiner to acquire a transaction result of the equipment indicated by the equipment information acquired by the equipment information acquirer in a secondhand products trading market, and determine whether or not there is a demand for the equipment in the secondhand products trading market on a basis of the transaction result; and
a solicitation notice transmitter to transmit, to the first terminal device, a listing solicitation notice prompting listing of the equipment on the secondhand products trading market when the demand determiner determines that there is a demand.

12. An information processing method comprising:
acquiring, from a first terminal device in which equipment owned by a user is registered, equipment information indicating the equipment;
acquiring a transaction result of the equipment indicated by the equipment information acquired in a secondhand products trading market, and determining whether or not there is a demand for the equipment in the secondhand products trading market on a basis of the transaction result; and
transmitting, to the first terminal device, a listing solicitation notice prompting listing of the equipment on the secondhand products trading market when the demand determiner determines that there is a demand.

13. A non-transitory computer readable storage medium storing an information processing program causing a computer to execute:
acquiring, from a first terminal device in which equipment owned by a user is registered, equipment information indicating the equipment;
acquiring a transaction result of the equipment indicated by the equipment information acquired in a secondhand products trading market, and determining whether or not there is a demand for the equipment in the secondhand products trading market on a basis of the transaction result; and
transmitting, to the first terminal device, a listing solicitation notice prompting listing of the equipment on the secondhand products trading market when the demand determiner determines that there is a demand.

14. An image display method comprising:
registering equipment owned by a user;
transmitting equipment information indicating the equipment registered to an equipment management server;
receiving a listing solicitation notice for prompting listing of the equipment on the secondhand products trading market from the equipment management server when the equipment management server determines that there is a demand for the equipment indicated by the equipment information in the secondhand products trading market; and
generating and outputting display data of a listing solicitation image indicating that listing of the equipment on the secondhand products trading market is prompted when the listing solicitation notice is received.

15. A non-transitory computer readable storage medium storing an image display program causing a computer to execute:
registering equipment owned by a user;
transmitting equipment information indicating the equipment registered to an equipment management server;
receiving a listing solicitation notice for prompting listing of the equipment on the secondhand products trading market from the equipment management server when the equipment management server determines that there is a demand for the equipment indicated by the equipment information in the secondhand products trading market; and
generating and outputting display data of a listing solicitation image indicating that listing of the equipment on the secondhand products trading market is prompted when the listing solicitation notice is received.

16. A product management server comprising:
processing circuitry to perform a process to:
acquire, from a first terminal device in which a product owned by a user is registered, product information indicating the product;
acquire a transaction result of the product indicated by the product information acquired in a secondhand products trading market, and determine whether or not there is a demand for the product in the secondhand products trading market on a basis of the transaction result; and
transmit, to the first terminal device, a listing solicitation notice prompting listing of the product on the secondhand products trading market when the process determines that there is a demand.

17. A terminal device comprising:
processing circuitry to perform a process to:
register a product owned by a user;
transmit product information indicating the product registered to a product management server;
receive a listing solicitation notice for prompting listing of the product on the secondhand products trading market from the product management server when the product management server determines that there is a demand for the product indicated by the product information in the secondhand products trading market; and
generate and output display data of a listing solicitation image indicating that listing of the product on the secondhand products trading market is prompted when the listing solicitation notice is received.
